(19) United States
(12) Patent Application Publication
(10) Pub. No.: US 2026/0244877 A1
(43) Pub. Date: Aug. 20, 2026

(54) GENERATING PERSONALIZED AI AGENT RESPONSES AND SUGGESTED PROMPTS USING CONTEXTUAL DATA

(71) Applicant: Salesforce, Inc., San Francisco, CA (US)

(72) Inventors: Kevin Marshall, Mill Valley, CA (US); Sara Bainbridge, Quebec (CA); Pratik Naik, San Francisco, CA (US); Blaine Scott Billingsley, Venice, CA (US); James Scheinblum, Oakland, CA (US)

(21) Appl. No.: 19/053,896

(22) Filed: Feb. 14, 2025

(51) Int. Cl. G06F 40/40; G06F 9/451; G06F 40/166; G06Q 10/1093

(52) U.S. Cl. CPC G06F 40/40; G06F 9/452; G06F 40/166; G06Q 10/1093; G06Q 10/1097

(57) ABSTRACT

A user may input text or select a suggested prompt via a user interface. Based on the text or the suggested prompt, an artificial intelligence (AI) agent associated with one or more models may extract contextual data associated with the user and store the contextual data in a database. The one or more models may utilize the contextual data to generate a response and/or one or more suggested follow up requests based in part on the user request. Subsequent contextual data associated with the user may be extracted and stored in the database based in part on determining the subsequent contextual data meets one or more criteria and/or is likely to affect subsequent responses and/or subsequent suggested prompts.

### TECHNICAL FIELD

The use of artificial intelligence (AI) and machine learning is increasingly becoming more popular due to its ability to enhance productivity and user experience. AI agents are software programs that leverage artificial intelligence techniques to understand and respond to user queries. However, AI chatbots can often struggle with understanding context of a user query. This leads to issues such as the AI chatbot providing irrelevant, repetitive, inconsistent responses or misinterpreting queries. This ultimately results in a suboptimal user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2A illustrates a user interface for a group-based communication system for certain examples.

FIG. 2B illustrates a user interface for multimedia collaboration sessions within the group-based communication system for certain examples.

FIG. 2C illustrates a user interface for inter-organization collaboration within the group-based communication system for certain examples.

FIG. 2D illustrates a user interface for collaborative documents within the group-based communication system for certain examples.

FIG. 3A depicts a user interface for workflows within a group-based communication system.

FIG. 3B depicts a block diagram for carrying out certain examples, as discussed herein.

FIG. 4 illustrates an example architecture utilized to generate responses and suggested prompts utilizing machine learning and/or a generative artificial intelligence (AI) agent.

FIG. 5 illustrates an example user interface associated with a communication platform displaying a plurality of suggested prompts.

FIG. 6 illustrates an example user interface associated with a communication platform displaying a first AI agent recommending a second AI Agent.

FIG. 7 illustrates an example user interface associated with a communication platform displaying user summary data generated by an AI Agent.

FIG. 8A illustrates an example user interface associated with a communication platform displaying a list generated by an AI Agent.

FIG. 8B illustrates an example user interface associated with a communication platform displaying a document generated by the AI agent.

FIG. 9 illustrates an example user interface associated with a communication platform displaying a suggested prompt associated with a calendar event.

FIG. 10 is a flow diagram illustrating an example process of receiving user input, selectively generating and/or extracting contextual data, and generating a response and/or a plurality of suggested follow-up prompts based in part on the user input.

### DETAILED DESCRIPTION

As discussed above, conventional chatbots often rely on pre-defined scripts or decision trees when generating responses to prompts, limiting the chatbot's ability to manage conversations and multi-step instructions. Techniques for generating and extracting contextual data associated with a user(s) are described herein. That is, an AI agent may be configured to perform a memory derivation process that enables the AI agent to track and maintain prior interactions with a user(s). The prior interactions and/or contextual data can be stored and accessed as needed in order to maintain context, coherence, and continuity of interactions with a user. The context of a conversation between a user and the AI agent (or multiple users) can be stored in a database (or memory) such that future interactions with the AI agent result in more customized responses for individual users.

As discussed herein, an AI agent may be configured to receive user input (e.g., a text string) or prompt. The prompt may be input into one more model(s) associated the AI agent. The model(s) may be utilized to extract metadata associated with a user that indicate relevant information related to one or more of professional context data (e.g., data related to a user role, company, industry, expertise, etc.), communication preference data (e.g., communication style, formality, preferred channels, favorite channels, etc.), personal preference data associated with a user (e.g., time zone, working hours, tools or applications the user interacts with, etc.), background information (e.g. location data, language skills, etc.), goals and priorities of the user (e.g., career objectives, current focus areas, projects, etc.), areas of interest or expertise (e.g., software development, human resources, education, awards and/or other acknowledgements, etc.), behavioral patterns (e.g., response times, communication style, etc.), and the like.

The extracted data may persist in a database. The database may be associated with a user account or profile. This extracted data may be utilized by model(s) associated with the AI agent to generate customized responses for a user or group of users. To provide a non-limiting example, the AI agent may receive a prompt from a user requesting an AI agent to “tell me what I should work on today.” In some examples, the model(s) associated with the AI agent be configured to access and/or extract relevant user data (e.g., from one or more databases) for the user that indicates that the user is working on a project to develop a new mobile application as well as data indicating the user has a calendar meeting scheduled with other users that are working on the same project. The model(s) may be configured to extract this relevant project data, calendar data, contact data, and prior communication data associated with the user and generate a customized response for the user. In this particular non-limiting example, model(s) associated with the AI agent may generate a response that suggests the user work on the new mobile application project, follow up on a communication with a user working on the same mobile application project, and/or suggest other prompts to the user.

In some examples, the AI agent is configured to store contextual data in a context database based in part on determining that the contextual data is likely to alter, modify, or affect subsequent responses and/or suggested prompts generated by the model(s) a threshold amount. That is, the model(s) may extract “memories” that would meaningfully change how an AI agent interacts with the user. The AI agent may continuous monitor how a user interacts with a communication platform. This enables the AI agent to remain up to date on information associated with a particular account, project, topic, event, etc.

In some examples, prior to generating contextual data to be stored in memory, model(s) may be utilized to determine whether a core meaning of the data already exists in any form so as to avoid storing multiple instances of metadata that indicates the same or similar insight or information. To provide a non-limiting example, existing contextual data in the context database may indicate that a particular user “prefers factual, measured language over hyperbolic terms in professional writing.” In this example, the AI agent may avoid generating and/or storing additional contextual data that indicates that the user (1) “shows strong preference for concise, factual writing,” (2) “values concrete language over exaggeration,” or (3) “favors precise, non-hyperbolic communication,” as this additional contextual data expresses the same or similar core preference stored in memory. Selectively generating and/or storing contextual data improves the functioning of computing systems at least by reducing noise, computational cost, and storage requirements.

In some examples, prior to storing contextual data, model(s) may be utilized to determine whether the contextual data meets one or more criteria and/or satisfying a threshold number of criteria. For example, model(s) may be utilized to determine a likelihood that contextual data is going to modify a manner in which the AI agent responds to a user(s). If the likelihood meets or exceeds a threshold, the contextual data may be stored in memory. If the likelihood does not meet or exceed the threshold, the data may not be stored. For example, the AI agent may avoid storing data that is “low-value,” such as routine task discussion, casual conversations between users, basic troubleshooting questions, sharing of routine documents, common workplace questions, information that is implied by a user but not explicitly stated, and the like.

The techniques described herein may reduce the amount of computational processing performed by computing system(s) and/or devices. For example, selectively storing contextual data that meets a threshold or other criteria can improve both memory efficiency and processing speed. Additionally, combining related contextual data (e.g., metadata) into a single data structure reduces memory redundancy by avoiding storing duplicative data. Furthermore, accessing a single data structure containing relevant metadata is faster than accessing multiple data structures, which require multiple separate lookups. That is, storing fewer data structures containing contextual data reduces the time needed to search for data and reduces storage usage (e.g., the system can perform tasks more efficiently). As such, systems structured in accordance with various examples of the disclosure provide specific, technical solutions to technical problems, the details of which are described herein.

For the purposes of this disclosure, the communication platform that hosts and/or maintains the AI agent and/or model(s) can be a group-based communication platform, a channel-based messaging platform, a sales-based platform, and/or any other platform for facilitating communication between and among users. Users can use a variety of devices (or “user devices”) to access the communication platform. Such devices may include any suitable type of computing device, e.g., portable, semi-portable, semi-stationary, or stationary. Some examples of a user device can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

### Group-Based Communication System

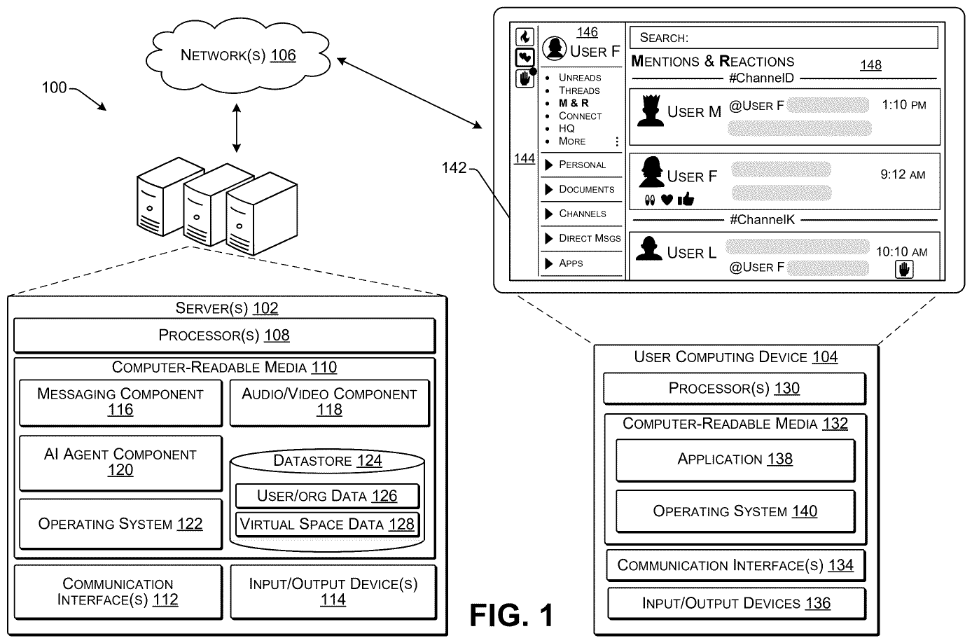

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example environment 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and/or input/output devices 114.

In at least one example, each processor of the processor(s) 108 can be a single processing unit or multiple processing units, and can include single or multiple computing units or multiple processing cores. The processor(s) 108 can be implemented as one or more microprocessors, microcomputers, microcontrollers, digital signal processors, central processing units (CPUs), graphics processing units (GPUs), tensor processing units (TPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include a messaging component 116, an audio/video component 118, an AI agent component 120, an operating system 122, and a datastore 124.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. Additionally, the messages can be transmitted in association with a collaborative document, canvas, or other collaborative space. In at least one example, the canvas can include a flexible canvas for curating, organizing, and sharing collections of information for a particular user and/or between multiple users. In at least one example, the collaborative document can be associated with a document identifier (e.g., virtual space identifier, communication channel identifier, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component 116 can establish a communication route between and among various user computing devices, allowing the user computing devices to communicate and share data between and among each other. In at least one example, the messaging component 116 can manage such communications and/or sharing of data. In some examples, data associated with a virtual space, such a collaborative document, can be presented via a user interface. In addition, metadata associated with each message transmitted via the virtual space, such as a timestamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component 116 can receive a message transmitted in association with a virtual space (e.g., direct message instance, communication channel, canvas, collaborative document, etc.). In various examples, the messaging component 116 can identify one or more users associated with the virtual space and can cause a rendering of the message in association with instances of the virtual space on respective user computing devices 104. In various examples, the messaging component 116 can identify the message as an update to the virtual space and, based on the identified update, can cause a notification associated with the update to be presented in association with a sidebar of user interface associated with one or more of the user(s) associated with the virtual space. For example, the messaging component 116 can receive, from a first user account, a message transmitted in association with a virtual space. In response to receiving the message (e.g., interaction data associated with an interaction of a first user with the virtual space), the messaging component 116 can identify a second user associated with the virtual space (e.g., another user that is a member of the virtual space). In some examples, the messaging component 116 can cause a notification of an update to the virtual space to be presented via a sidebar of a user interface associated with a second user account of the second user. In some examples, the messaging component 116 can cause the notification to be presented in response to a determination that the sidebar of the user interface associated with the second user account includes an affordance associated with the virtual space. In such examples, the notification can be presented in association with the affordance associated with the virtual space.

In various examples, the messaging component 116 can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier, such as in association with an affordance associated with the virtual space in a sidebar of a user interface associated with the particular user and/or in a virtual space associated with mentions and reactions. That is, the messaging component 116 can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio and/or video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component 116 and/or other components of the server(s) 102, to transmit communications in association with other virtual spaces that are associated with the virtual headquarters. That is, the messaging component 116 can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In at least some examples, the AI agent component 120 may utilize one or more model(s) to generate response(s) to a prompt. The model(s) can be a large language model such as a generative pre-trained transformer 3, a bidirectional encoder representations transformer, text-to-text transfer transformer, XLNet, and the like. In some examples, the AI agent component may be trained to access and/or retrieve data from a particular database or source.

The AI agent component 120 may be configured to perform a memory derivation process, which enables the AI agent component 120 to track and maintain prior interactions with a user(s). For example, metadata associated with prior interactions can be extracted, stored, and accessed at a later time in order to maintain context, coherence, and continuity of interactions with a user. That is, the context of a conversation between a user (or multiple users) can be stored in a database (or memory) such that future interactions with the AI agent result in more customized responses for individual users. In some examples, interactions with a user(s) are stored in a database (e.g., datastore 124) associated with the user account(s).

In some examples, the AI agent component 120 may be configured to extract data that is relevant for generating personalized responses for a user. For example, the AI agent component 120 may extract data associated with a user account, such as username, email address, location, title (e.g., job role or position), workspaces, user groups associated with the user, messages and threads, file uploads, shared files, permissions, and the like. In some examples, the AI agent component may extract data associated with a user account that indicates a type of work performed by the user (e.g., software engineer, sales, marketing, etc.), work hours, interests, areas of expertise, communication style, and the like. The extracted data may persist in a database associated with a user account or profile. This extracted data may then be utilized by the AI agent component 120 to generate customized responses for the user associated with a particular user account. To provide a non-limiting example, model(s) associated with the AI agent component 120 may receive a prompt from a user requesting an AI agent to “tell me what I should work on today.” In some examples, the model(s) associated with the AI agent component 120 be configured to receive, access and/or extract relevant user data (e.g., from one or more databases) for the user that indicates that the user is working on a project to develop a new mobile application as well as data indicating the user has a calendar meeting scheduled with other users that working on the same project. The AI agent component 120 may be configured to extract this relevant project data, calendar data, contact data, and prior communication data associated with the user and generate a customized response for the user. In this particular non-limiting example, the AI agent component may generate a response that suggests the user work on the new mobile application project, follow up on a communication with a user working on the same mobile application project, and/or suggest other prompts to the user.

In some examples, the AI agent component 120 can indirectly invoke an API. For example, instead of calling an API directly, the AI agent component (e.g., the model(s) associated with the AI agent component) can perform a web search for data from publicly available sources, such as search engines or web pages.

In some examples, the communication platform can manage communication channels. In some examples, the communication platform can be a channel-based messaging platform, that in some examples, can be usable by group(s) of users. Users of the communication platform can communicate with other users via communication channels. A communication channel, or virtual space, can be a data route used for exchanging data between and among systems and devices associated with the communication platform. In some examples, a channel can be a virtual space where people can post messages, documents, and/or files. In some examples, access to channels can be controlled by permissions. In some examples, channels can be limited to a single organization, shared between different organizations, public, private, or special channels (e.g., hosted channels with guest accounts where guests can make posts but are prevented from performing certain actions, such as inviting other users to the channel). In some examples, some users can be invited to channels via email, channel invites, direct messages, text messages, and the like. Examples of channels and associated functionality are discussed throughout this disclosure.

In at least one example, the operating system 122 can manage the processor(s) 108, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include user/org data 126 and/or virtual space data 128. Additional or alternative data may be stored in the data store and/or one or more other data stores.

In at least one example, the user/org data 126 can include data associated with users of the communication platform. In at least one example, the user/org data 126 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 126 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 126. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 126 can include data associated with one or more organizations of the communication platform. In at least one example, the user/org data 126 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 128 can include data associated with one or more virtual spaces associated with the communication platform. The virtual space data 128 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

In some examples, such as when a channel is shared between two organizations, each organization can be associated with its own encryption key. When a user associated with one organization posts a message or file to the shared channel it can be encrypted in the datastore 124 with the encryption key specific to the organization and the other organization can decrypt the message or file prior to accessing the message or file. Further, in examples where organizations are in different geographical areas, data associated with a particular organization can be stored in a location corresponding to the organization and temporarily cached at a location closer to a client (e.g., associated with the other organization) when such messages or files are to be accessed. Data can be maintained, stored, and/or deleted in the datastore 124 in accordance with a data governance policy associated with each specific organization.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via WebSockets, Application Programming Interfaces (APIs) (e.g., using API calls), Hypertext Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 130, computer-readable media 132, one or more communication interfaces 134, and input/output devices 136.

In at least one example, each processor of the processor(s) 130 can be a single processing unit or multiple processing units, and can include single or multiple computing units or multiple processing cores. The processor(s) 130 can comprise any of the types of processors described above with reference to the processor(s) 108 and may be the same as or different than the processor(s) 108.

The computer-readable media 132 can comprise any of the types of computer-readable media 132 described above with reference to the computer-readable media 110 and may be the same as or different than the computer-readable media 110. Functional components stored in the computer-readable media can optionally include at least one application 138 and an operating system 140.

In at least one example, the application 138 can be a mobile application, a web application, or a desktop application, which can be provided by the communication platform or which can be an otherwise dedicated application. In some examples, individual user computing devices associated with the environment 100 can have an instance or versioned instance of the application 138, which can be downloaded from an application store, accessible via the Internet, or otherwise executable by the processor(s) 130 to perform operations as described herein. That is, the application 138 can be an access point, enabling the user computing device 104 to interact with the server(s) 102 to access and/or use communication services available via the communication platform. In at least one example, the application 138 can facilitate the exchange of data between and among various other user computing devices, for example via the server(s) 102. In at least one example, the application 138 can present user interfaces, as described herein. In at least one example, a user can interact with the user interfaces via touch input, keyboard input, mouse input, spoken input, or any other type of input.

A non-limiting example of a user interface 142 is shown in FIG. 1. In some examples, the user interface 142 can present data associated with one or more virtual spaces, which may include one or more workspaces. That is, in some examples, the user interface 142 can integrate data from multiple workspaces into a single user interface so that the user (e.g., of the user computing device 104) can access and/or interact with data associated with the multiple workspaces that he or she is associated with and/or otherwise communicate with other users associated with the multiple workspaces. In some examples, the user interface 142 can include a first region 144, or pane, that includes indicator(s) (e.g., user interface element(s) or object(s)) associated with workspace(s) with which the user (e.g., account of the user) is associated. In some examples, the user interface 142 can include a second region 146, or pane, that includes indicator(s) (e.g., user interface element(s), affordance(s), object(s), etc.) representing data associated with the workspace(s) with which the user (e.g., account of the user) is associated. In at least one example, the second region 146 can represent a sidebar of the user interface 142.

In at least one example, the user interface 142 can include a third region 148, or pane, that can be associated with a data feed (or, “feed”) indicating suggested prompts for users of the virtual space to initiate, messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 148 can be associated with the same or different workspaces. That is, in some examples, the third region 148 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 148 presents data associated with multiple workspaces, at least some data can be associated with an indication of which workspace the data is associated with. In some examples, the third region 148 may be resized or popped out as a standalone window.

In at least one example, the operating system 140 can manage the processor(s) 130, computer-readable media 132, hardware, software, etc. of the server(s) 102.

The communication interface(s) 134 can include one or more interfaces and hardware components for enabling communication with various other devices (e.g., the user computing device 104), such as over the network(s) 106 or directly. In some examples, the communication interface(s) 134 can facilitate communication via WebSockets, APIs (e.g., using API calls), HTTPs, etc.

The user computing device 104 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

While techniques described herein are described as being performed by the messaging component 116, the audio/video component 118, and the application 138, techniques described herein can be performed by any other component, or combination of components, which can be associated with the server(s) 102, the user computing device 104, or a combination thereof.

### User Interface for a Group-Based Communication System

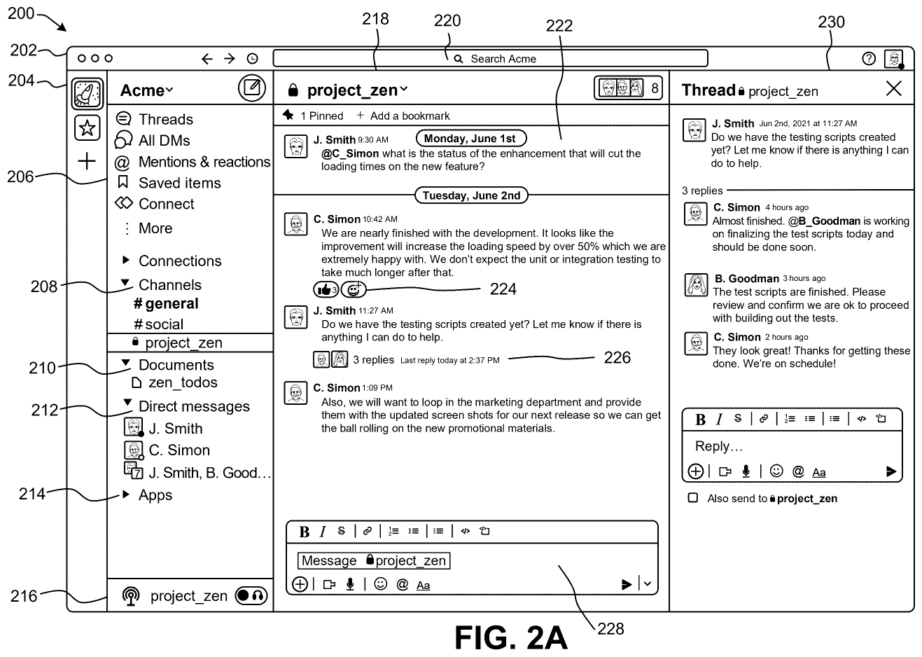

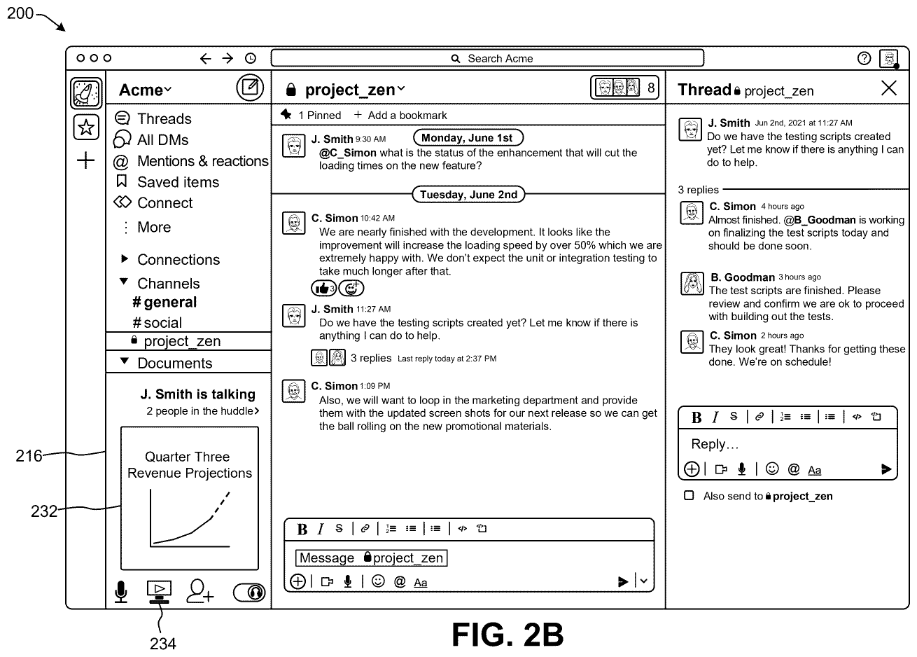

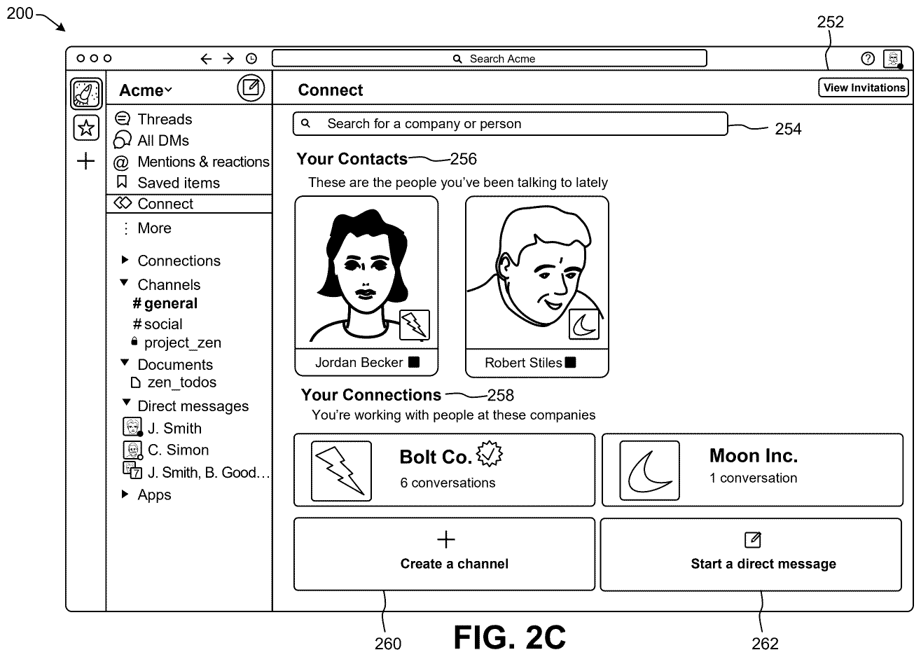

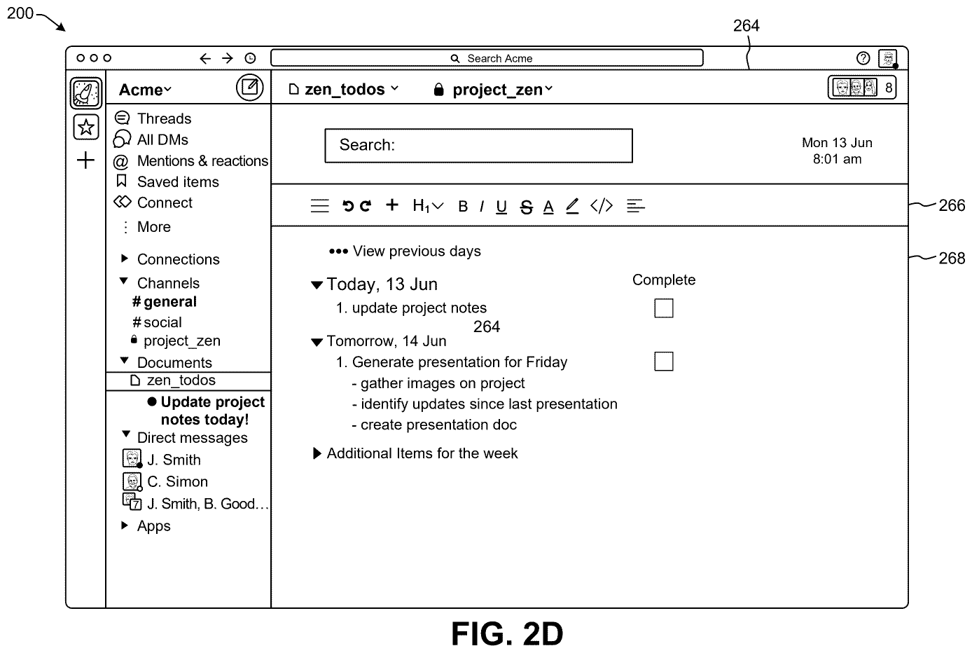

FIG. 2A illustrates a user interface 200 of a group-based communication system, which will be useful in illustrating the operation of various examples discussed herein. The group-based communication system may include communication data such as messages, queries, files, mentions, users or user profiles, interactions, tickets, channels, applications integrated into one or more channels, conversations, workspaces, or other data generated by or shared between users of the group-based communication system. In some instances, the communication data may comprise data associated with a user, such as a user identifier, channels to which the user has been granted access, groups with which the user is associated, permissions, and other user-specific information.

The user interface 200 comprises a plurality of objects such as panes, text entry fields, buttons, messages, or other user interface components that are viewable by a user of the group-based communication system. As depicted, the user interface 200 comprises a title bar 202, a workspace pane 204, a navigation pane 206, channels 208, documents 210 (e.g., collaborative documents), direct messages 212, applications 214, a synchronous multimedia collaboration session pane 216, and channel pane 218.

By way of example and without limitation, when a user opens the user interface 200 they can select a workspace via the workspace pane 204. A particular workspace may be associated with data specific to the workspace and accessible via permissions associated with the workspace. Different sections of the navigation pane 206 can present different data and/or options to a user. Different graphical indicators may be associated with virtual spaces (e.g., channels) to summarize an attribute of the channel (e.g., whether the channel is public, private, shared between organizations, locked, etc.). When a user selects a channel, a channel pane 218 may be presented. In some examples, the channel pane 218 can include a header, pinned items (e.g., documents or other virtual spaces), an “about” document providing an overview of the channel, and the like. In some cases, members of a channel can search within the channel, access content associated with the channel, add other members, post content, and the like. In some examples, depending on the permissions associated with a channel, users who are not members of the channel may have limited ability to interact with (or even view or otherwise access) a channel. As users navigate within a channel they can view messages 222 and may react to messages (e.g., a reaction button 224), reply in a thread, start threads, and the like. Further, a channel pane 218 can include a compose pane 228 to compose message(s) and/or other data to associate with a channel. In some examples, the user interface 200 can include a thread pane 230 that provides additional levels of detail of the messages 222. In some examples, different panes can be resized, panes can be popped out to independent windows, and/or independent windows can be merged to multiple panes of the user interface 200. In some examples, users may communicate with other users via a collaboration pane 216, which may provide synchronous or asynchronous voice and/or video capabilities for communication. Of course, these are illustrative examples and additional examples of the aforementioned features are provided throughout this disclosure.

In some examples, title bar 202 comprises search bar 220. The search bar 220 may allow users to search for content located in the current workspace of the group-based communication system, such as files, messages, channels, members, commands, functions, and the like. Users may refine their searches by attributes such as content type, content author, and by users associated with the content. Users may optionally search within specific workspaces, channels, direct message conversations, or documents. In some examples, the title bar 202 comprises navigation commands allowing a user to move backwards and forwards between different panes, as well as to view a history of accessed content. In some examples, the title bar 202 may comprise additional resources such as links to help documents and user configuration settings.

In some examples, the group-based communication system can comprise a plurality of distinct workspaces, where each workspace is associated with different groups of users and channels. Each workspace can be associated with a group identifier and one or more user identifiers can be mapped to, or otherwise associated with, the group identifier. Users corresponding to such user identifiers may be referred to as members of the group. In some examples, the user interface 200 comprises the workspace pane 204 for navigating between, adding, or deleting various workspaces in the group-based communication system. For example, a user may be a part of a workspace for Acme, where the user is an employee of or otherwise affiliated with Acme. The user may also be a member of a local volunteer organization that also uses the group-based communication system to collaborate. To navigate between the two groups, the user may use the workspace pane 204 to change from the Acme workspace to the volunteer organization workspace. A workspace may comprise one or more channels that are unique to that workspace and/or one or more channels that are shared between one or more workspaces. For example, the Acme company may have a workspace for Acme projects, such as Project Zen, a workspace for social discussions, and an additional workspace for general company matters. In some examples, an organization, such as a particular company, may have a plurality of workspaces, and the user may be associated with one or more workspaces belonging to the organization. In yet other examples, a particular workspace can be associated with one or more organizations or other entities associated with the group-based communication system.

In some examples, the navigation pane 206 permits users to navigate between virtual spaces such as pages, channels 208, collaborative documents 210 (such as those discussed at FIG. 2D), applications 214, and direct messages 212 within the group-based communication system. For example, the navigation pane 206 can include indicators representing virtual spaces that can aggregate data associated with a plurality of virtual spaces of which the user is a member. In at least one example, each virtual space can be associated with an indicator in the navigation pane 206. In some examples, an indicator can be associated with an actuation mechanism (e.g., an affordance, also referred to as a graphical element) such that when actuated, can cause the user interface 200 to present data associated with the corresponding virtual space. In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented, for example in a feed. In such examples, different types of events and/or actions, which can be associated with different virtual spaces, can be presented via the same feed. In some examples, such data can be organized and/or is sortable by associated virtual space (e.g., virtual space via which the communication was transmitted), time, type of action, user, and/or the like. In some examples, such data can be associated with an indication of which user (e.g., member of the associated virtual space) posted the message and/or performed an action.

In some examples, a virtual space can be associated with the same type of event and/or action. For example, “threads” can be associated with messages, files, etc. posted in threads to messages posted in a virtual space and “mentions and reactions” can be associated with messages or threads where the user has been mentioned (e.g., via a tag) or another user has reacted (e.g., via an emoji, reaction, or the like) to a message or thread posted by the user. That is, in some examples, the same types of events and/or actions, which can be associated with different virtual spaces, can be presented via the same feed. As with the “unreads” virtual space, data associated with such virtual spaces can be organized and/or is sortable by virtual space, time, type of action, user, and/or the like.

In some examples, a virtual space can be associated with facilitating communications between a user and other users of the communication platform. For example, “connect” can be associated with enabling the user to generate invitations to communicate with one or more other users. In at least one example, responsive to receiving an indication of selection of the “connect” indicator, the communication platform can cause a connections interface to be presented.

In some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 200. In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

In some examples, a virtual space can be associated with a group (e.g., organization, team, etc.) headquarters (e.g., administrative or command center). In at least one example, the group headquarters can include a virtual or digital headquarters for administrative or command functions associated with a group of users. For example, “HQ” can be associated with an interface including a list of indicators associated with virtual spaces configured to enable associated members to communicate. In at least one example, the user can associate one or more virtual spaces with the “HQ” virtual space, such as via a drag and drop operation. That is, the user can determine relevant virtual space(s) to associate with the virtual or digital headquarters, such as to associate virtual space(s) that are important to the user therewith.

In some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 200. In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

Additionally or in the alternative, in some examples, a virtual space can be associated with one or more canvases with which the user is associated. In at least one example, the canvas can include a flexible canvas for curating, organizing, and sharing collections of information between users. That is, the canvas can be configured to be accessed and/or modified by two or more users with appropriate permissions. In at least one example, the canvas can be configured to enable sharing of text, images, videos, GIFs, drawings (e.g., user-generated drawing via a canvas interface), gaming content (e.g., users manipulating gaming controls synchronously or asynchronously), and/or the like. In at least one example, modifications to a canvas can include adding, deleting, and/or modifying previously shared (e.g., transmitted, presented) data. In some examples, content associated with a canvas can be shareable via another virtual space, such that data associated with the canvas is accessible to and/or rendered interactable for members of the virtual space.

The navigation pane 206 may further comprise indicators representing communication channels (e.g., the channels 208). In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user may be associated with both workspaces, or may only be associated with one of the workspaces. In some examples, the communication channels represented can be associated with combinations of communication channels associated with a single workspace and communication channels associated with different workspaces.

In some examples, the navigation pane 206 may depict some or all of the communication channels that the user has permission to access (e.g., as determined by the permission data). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the navigation pane 206 can depict some or all of the communication channels that the user is a member of, and the user can interact with the user interface 200 to browse or view other communication channels that the user is not a member of but are not currently displayed in the navigation pane 206. In some examples, different types of communication channels (e.g., public, private, shared, cross-workspace, etc.) can be in different sections of the navigation pane 206, or can have their own sub-regions or sub-panes in the user interface 200. In some examples, communication channels associated with different workspaces can be in different sections of the navigation pane 206, or can have their own regions or panes in the user interface 200.

In some examples, the indicators can be associated with graphical elements that visually differentiate types of communication channels. For example, project_zen is associated with a lock graphical element. As a non-limiting example, and for the purpose of this discussion, the lock graphical element can indicate that the associated communication channel, project_zen, is private and access thereto is limited, whereas another communication channel, general, is public and access thereto is available to any member of an organization with which the user is associated. In some examples, additional or alternative graphical elements can be used to differentiate between shared communication channels, communication channels associated with different workspaces, communication channels with which the user is or is not a current member, and/or the like.

In at least one example, the navigation pane 206 can include indicators representative of communications with individual users or multiple specified users (e.g., instead of all, or a subset of, members of an organization). Such communications can be referred to as “direct messages.” The navigation pane 206 can include indicators representative of virtual spaces that are associated with private messages between one or more users.

The direct messages 212 may be communications between a first user and a second user, or they may be multi-person direct messages between a first user and two or more second users. The navigation pane 206 may be sorted and organized into hierarchies or sections depending on the user's preferences. In some examples, all of the channels to which a user has been granted access may appear in the navigation pane 206. In other examples, the user may choose to hide certain channels or collapse sections containing certain channels. Items in the navigation pane 206 may indicate when a new message or update has been received or is currently unread, such as by bolding the text associated with a channel in which an unread message is located or adding an icon or badge (for example, with a count of unread messages) to the channel name. In some examples, the group-based communication system may additionally or alternatively store permissions data associated with permissions of individual users of the group-based communication system, indicating which channels a user may view or join. Permissions can indicate, for example, which users can communicate directly with other users, which channels a user is permitted to access, restrictions on individual channels, which workspaces the user is permitted to access, and restrictions on individual workspaces.

Additionally or in the alternative, the navigation pane 206 can include a sub-section that is a personalized sub-section associated with a team of which the user is a member. That is, the “team” sub-section can include affordance(s) of one or more virtual spaces that are associated with the team, such as communication channels, collaborative documents, direct messaging instances, audio or video synchronous or asynchronous meetings, and/or the like. In at least one example, the user can associate selected virtual spaces with the team sub-section, such as by dragging and dropping, pinning, or otherwise associating selected virtual spaces with the team sub-section.

### Channels Within the Group-Based Communication System

In some examples, the group-based communication system is a channel-based messaging platform, as shown in FIG. 2A. Within the group-based communication system, communication may be organized into channels, each dedicated to a particular topic and a set of users. Channels are generally a virtual space relating to a particular topic comprising messages and files posted by members of the channel.

For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message may include any text, image, video, audio, or combination thereof provided by a user (using a user computing device). For instance, the user may provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers may comprise American Standard Code for Information Interchange (ASCII) text, a pointer, a memory address, or the like.

The channel discussion may persist for days, months, or years and provide a historical log of user activity. Members of a particular channel can post messages within that channel that are visible to other members of that channel together with other messages in that channel. Users may select a channel for viewing to see only those messages relevant to the topic of that channel without seeing messages posted in other channels on different topics. For example, a software development company may have different channels for each software product being developed, where developers working on each particular project can converse on a generally singular topic (e.g., project) without noise from unrelated topics. Because the channels are generally persistent and directed to a particular topic or group, users can quickly and easily refer to previous communications for reference. In some examples, the channel pane 218 may display information related to a channel that a user has selected in the navigation pane 206. For example, a user may select the project_zen channel to discuss the ongoing software development efforts for Project Zen. In some examples, the channel pane 218 may include a header comprising information about the channel, such as the channel name, the list of users in the channel, and other channel controls. Users may be able to pin items to the header for later access and add bookmarks to the header. In some examples, links to collaborative documents may be included in the header. In further examples, each channel may have a corresponding virtual space which includes channel-related information such as a channel summary, tasks, bookmarks, pinned documents, and other channel-related links which may be editable by members of the channel.

A communication channel or other virtual space can be associated with data and/or content other than messages, or data and/or content that is associated with messages. For example, non-limiting examples of additional data that can be presented via the channel pane 218 of the user interface 200 include collaborative documents (e.g., documents that can be edited collaboratively, in real-time or near real-time, etc.), audio and/or video data associated with a conversation, members added to and/or removed from the communication channel, file(s) (e.g., file attachment(s)) uploaded and/or removed from the communication channel), application(s) added to and/or removed from the communication channel, post(s) (data that can be edited collaboratively, in near real-time by one or members of a communication channel) added to and/or removed from the communication channel, description added to, modified, and/or removed from the communication channel, modifications of properties of the communication channel, etc.

The channel pane 218 may include messages such as message 222, which is content posted by a user into the channel. Users may post text, images, videos, audio, or any other file as the message 222. In some examples, particular identifiers (in messages or otherwise) may be denoted by prefixing them with predetermined characters. For example, channels may be prefixed by the “#” character (as in #project_zen) and username may be prefixed by the “@” character (as in @J_Smith or @User_A). Messages such as the message 222 may include an indication of which user posted the message and the time at which the message was posted. In some examples, users may react to messages by selecting a reaction button 224. The reaction button 224 allows users to select an icon (sometimes called a reacji in this context), such as a thumbs up, to be associated with the message. Users may respond to messages, such as the message 222, of another user with a new message. In some examples, such conversations in channels may further be broken out into threads. Threads may be used to aggregate messages related to a particular conversation together to make the conversation easier to follow and reply to, without cluttering the main channel with the discussion. Under the message beginning the thread appears a thread reply preview 226. The thread reply preview 226 may show information related to the thread, such as, for example, the number of replies and the members who have replied. Thread replies may appear in a thread pane 230 that may be separate from the channel pane 218 and may be viewed by other members of the channel by selecting the thread reply preview 226 in the channel pane 218.

In some examples, one or both of the channel pane 218 and the thread pane 230 may include a compose pane 228. In some examples, the compose pane 228 allows users to compose and transmit messages 222 to the members of the channel or to those members of the channel who are following the thread (when the message is sent in a thread). The compose pane 228 may have text editing functions such as bold, strikethrough, and italicize, and/or may allow users to format their messages or attach files such as collaborative documents, images, videos, or any other files to share with other members of the channel. In some examples, the compose pane 228 may enable additional formatting options such as numbered or bulleted lists via either the user interface or an API. The compose pane 228 may also function as a workflow trigger to initiate workflows related to a channel or message. In further examples, links or documents sent via the compose pane 228 may include unfurl instructions related to how the content should be displayed.

### Synchronous Multimedia Collaboration Sessions

FIG. 2B illustrates a multimedia collaboration session (e.g., a synchronous multimedia collaboration session) that has been triggered from a channel, as shown in pane 216. Synchronous multimedia collaboration sessions may provide ambient, ad hoc multimedia collaboration in the group-based communication system. Users of the group-based communication system can quickly and easily join and leave these synchronous multimedia collaboration sessions at any time, without disrupting the synchronous multimedia collaboration session for other users. In some examples, synchronous multimedia collaboration sessions may be based around a particular topic, a particular channel, a particular direct message or multi-person direct message, or a set of users, while in other examples, synchronous multimedia collaboration sessions may exist without being tied to any channel, topic, or set of users.

Synchronous multimedia collaboration session pane 216 may be associated with a session conducted for a plurality of users in a channel, users in a multi-person direct message conversation, or users in a direct message conversation. Thus, a synchronous multimedia collaboration session may be started for a particular channel, multi-person direct message conversation, or direct message conversation by one or more members of that channel or conversation. Users may start a synchronous multimedia collaboration session in a channel as a means of communicating with other members of that channel who are presently online. For example, a user may have an urgent decision and want immediate verbal feedback from other members of the channel. As another example, a synchronous multimedia collaboration session may be initiated with one or more other users of the group-based communication system through direct messaging. In some examples, the audience of a synchronous multimedia collaboration session may be determined based on the context in which the synchronous multimedia collaboration session was initiated. For example, starting a synchronous multimedia collaboration session in a channel may automatically invite the entire channel to attend. As another example. Starting a synchronous multimedia collaboration session allows the user to start an immediate audio and/or video conversation with other members of the channel without requiring scheduling or initiating a communication session through a third-party interface. In some examples, users may be directly invited to attend a synchronous multimedia collaboration session via a message or notification.

Synchronous multimedia collaboration sessions may be short, ephemeral sessions from which no data is persisted. Alternatively, in some examples, synchronous multimedia collaboration sessions may be recorded, transcribed, and/or summarized for later review. In other examples, contents of the synchronous multimedia collaboration session may automatically be persisted in a channel associated with the synchronous multimedia collaboration session. Members of a particular synchronous multimedia collaboration session can post messages within a messaging thread associated with that synchronous multimedia collaboration session that are visible to other members of that synchronous multimedia collaboration session together with other messages in that thread.

The multimedia in a synchronous multimedia collaboration session may include collaboration tools such as any or all of audio, video, screen sharing, collaborative document editing, whiteboarding, co-programming, or any other form of media. Synchronous multimedia collaboration sessions may also permit a user to share the user's screen with other members of the synchronous multimedia collaboration session. In some examples, members of the synchronous multimedia collaboration session may mark-up, comment on, draw on, or otherwise annotate a shared screen. In further examples, such annotations may be saved and persisted after the synchronous multimedia collaboration session has ended. A canvas may be created directly from a synchronous multimedia collaboration session to further enhance the collaboration between users.

In some examples, a user may start a synchronous multimedia collaboration session via a toggle in synchronous multimedia collaboration session pane 216 shown in FIG. 2B. Once a synchronous multimedia collaboration session has been started, synchronous multimedia collaboration session pane 216 may be expanded to provide information about the synchronous multimedia collaboration session such as how many members are present, which user is currently talking, which user is sharing the user's screen, and/or screen share preview 232. In some examples, users in the synchronous multimedia collaboration session may be displayed with an icon indicating that they are participating in the synchronous multimedia collaboration session. In further examples, an expanded view of the participants may show which users are active in the synchronous multimedia collaboration session and which are not. Screen share preview 232 may depict the desktop view of a user sharing the user's screen, or a particular application or presentation. Changes to the user's screen, such as the user advancing to the next slide in a presentation, will automatically be depicted in screen share preview 232. In some examples, the screen share preview 232 may be actuated to cause the screen share preview 232 to be enlarged such that it is displayed as its own pane within the group-based communication system. In some examples, the screen share preview 232 can be actuated to cause the screen share preview 232 to pop out into a new window or application separate and distinct from the group-based communication system. In some examples, the synchronous multimedia collaboration session pane 216 may comprise tools for the synchronous multimedia collaboration session allowing a user to mute the user's microphone or invite other users. In some examples, the synchronous multimedia collaboration session pane 216 may comprise a screen share button 234 that may permit a user to share the user's screen with other members of the synchronous multimedia collaboration session pane 216. In some examples, the screen share button 234 may provide a user with additional controls during a screen share. For example, a user sharing the user's screen may be provided with additional screen share controls to specify which screen to share, to annotate the shared screen, or to save the shared screen.

In some cases, the synchronous multimedia collaboration session pane 216 may persist in the navigation pane 206 regardless of the state of the group-based communication system. In some examples, when no synchronous multimedia collaboration session is active and/or depending on which item is selected from the navigation pane 206, the synchronous multimedia collaboration session pane 216 may be hidden or removed from being presented via the user interface 200. In some instances, when the pane 216 is active, the pane 216 can be associated with a currently selected channel, direct message, or multi-person direct message such that a synchronous multimedia collaboration session may be initiated and associated with the currently selected channel, direct message, or multi-person direct message.

A list of synchronous multimedia collaboration sessions may include one or more active synchronous multimedia collaboration sessions selected for recommendation. For example, the synchronous multimedia collaboration sessions may be selected from a plurality of currently active synchronous multimedia collaboration sessions. Further, the synchronous multimedia collaboration sessions may be selected based in part on user interaction with the sessions or some association of the instant user with the sessions or users involved in the sessions. For example, the recommended synchronous multimedia collaboration sessions may be displayed based in part on the instant user having been invited to a respective synchronous multimedia collaboration session or having previously collaborated with the users in the recommended synchronous multimedia collaboration session. In some examples, the list of synchronous multimedia collaboration sessions further includes additional information for each respective synchronous multimedia collaboration session, such as an indication of the participating users or number of participating users, a topic for the synchronous multimedia collaboration session, and/or an indication of an associated group-based communication channel, multi-person direct message conversation, or direct message conversation.

In some examples, a list of recommended active users may include a plurality of group-based communication system users recommended based on at least one of user activity, user interaction, or other user information. For example, the list of recommended active users may be selected based on an active status of the users within the group-based communication system; historic, recent, or frequent user interaction with the instant user (such as communicating within the group-based communication channel); or similarity between the recommended users and the instant user (such as determining that a recommended user shares common membership in channels with the instant user). In some examples, machine learning techniques such as cluster analysis can be used to determine recommended users. The list of recommended active users may include status user information for each recommended user, such as whether the recommended user is active, in a meeting, idle, in a synchronous multimedia collaboration session, or offline. In some examples, the list of recommended active users further comprises a plurality of actuatable buttons corresponding to some of or all the recommended users (for example, those recommended users with a status indicating availability) that, when selected, may be configured to initiate at least one of a text-based communication session (such as a direct message conversation) or a synchronous multimedia collaboration session.

In some examples, one or more recommended asynchronous multimedia collaboration sessions or meetings can be displayed in an asynchronous meeting section. By contrast with a synchronous multimedia collaboration session (described above), an asynchronous multimedia collaboration session allows each participant to collaborate at a time convenient to them. This collaboration participation is then recorded for later consumption by other participants, who can generate additional multimedia replies. In some examples, the replies are aggregated in a multimedia thread (for example, a video thread) corresponding to the asynchronous multimedia collaboration session. For example, an asynchronous multimedia collaboration session may be used for an asynchronous meeting where a topic is posted in a message at the beginning of a meeting thread and participants of the meeting may reply by posting a message or a video response. The resulting thread then comprises any documents, video, or other files related to the asynchronous meeting. In some examples, a preview of a subset of video replies may be shown in the asynchronous collaboration session or thread. This can allow, for example, a user to jump to a relevant segment of the asynchronous multimedia collaboration session or to pick up where they left off previously.

### Connecting Within the Group-Based Communication System

FIG. 2C illustrates user interface 200 displaying a connect pane 252. The connect pane 252 may provide tools and resources for users to connect across different organizations, where each organization may have their own (normally private) instance of the group-based communication system or may not yet belong to the group-based communication system. For example, a first software company may have a joint venture with a second software company with whom they wish to collaborate on jointly developing a new software application. The connect pane 252 may enable users to determine which other users and organizations are already within the group-based communication system, and to invite those users and organizations currently outside of the group-based communication system to join.

The connect pane 252 may comprise a connect search bar 254, recent contacts 256, connections 258, a create channel button 260, and/or a start direct message button 262. In some examples, the connect search bar 254 may permit a user to search for users within the group-based communication system. In some examples, only users from organizations that have connected with the user's organization will be shown in the search results. In other examples, users from any organization that uses the group-based communication system can be displayed. In still other examples, users from organizations that do not yet use the group-based communication can also be displayed, allowing the searching user to invite them to join the group-based communication system. In some examples, users can be searched for via their group-based communication system username or their email address. In some examples, email addresses may be suggested or autocompleted based on external sources of data such as email directories or the searching user's contact list.

In some examples, external organizations as well as individual users may be shown in response to a user search. External organizations may be matched based on an organization name or internet domain, as search results may include organizations that have not yet joined the group-based communication system (similar to searching and matching for a particular user, discussed above). External organizations may be ranked based in part on how many users from the user's organization have connected with users of the external organization. Responsive to a selection of an external organization in a search result, the searching user may be able to invite the external organization to connect via the group-based communication system.

In some examples, the recent contacts 256 may display users with whom the instant user has recently interacted. The recent contacts 256 may display the user's name, company, and/or a status indication. The recent contacts 256 may be ordered based on which contacts the instant user most frequently interacts with or based on the contacts with whom the instant user most recently interacted. In some examples each recent contact of the recent contacts 256 may be an actuatable control allowing the instant user to quickly start a direct message conversation with the recent contact, invite them to a channel, or take any other appropriate user action for that recent contact.

In some examples, the connections 258 may display a list of companies (e.g., organizations) with which the user has interacted. For each company, the name of the company may be displayed along with the company's logo and an indication of how many interactions the user has had with the company, for example the number of conversations. In some examples, each connection of the connections 258 may be an actuatable control allowing the instant user to quickly invite the external organization to a shared channel, display recent connections with that external organization, or take any other appropriate organization action for that connection.

In some examples, the create channel button 260 allows a user to create a new shared channel between two different organizations. Selecting the create channel button 260 may further allow a user to name the new connect channel and enter a description for the connect channel. In some examples, the user may select one or more external organizations or one or more external users to add to the shared channel. In other examples, the user may add external organizations or external users to the shared channel after the shared channel is created. In some examples, the user may elect whether to make the connect channel private (e.g., accessible only by invitation from a current member of the private channel).

In some examples, the start direct message button 262 allows a user to quickly start a direct message (or multi-person direct message) with external users at an external organization. In some examples, the external user identifier at an external organization may be supplied by the instant user as the external user's group-based communication system username or as the external user's email address. In some examples, an analysis of the email domain of the external user's email address may affect the message between the user and the external user. For example, the external user's identifier may indicate (for example, based on an email address domain) that the user's organization and the external user's organization are already connected. In some such examples, the email address may be converted to a group-based communication system username. Alternatively, the external user's identifier may indicate that the external user's organization belongs to the group-based communication system but is not connected to the instant user's organization. In some such examples, an invitation to connect to the instant user's organization may be generated in response. As another alternative, the external user may not be a member of the group-based communication system, and an invitation to join the group-based communication system as a guest or a member may be generated in response.

### Collaborative Documents

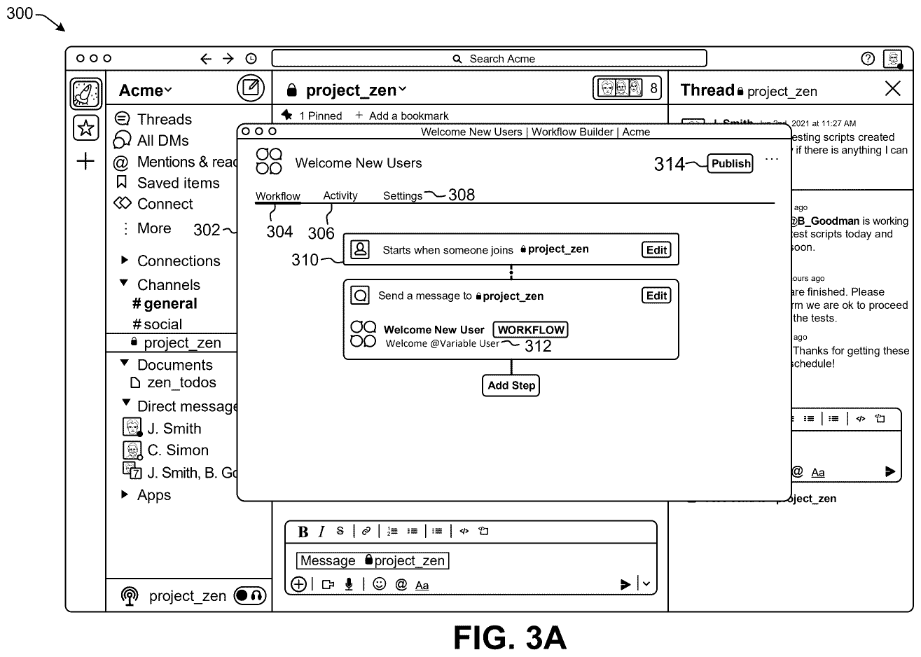

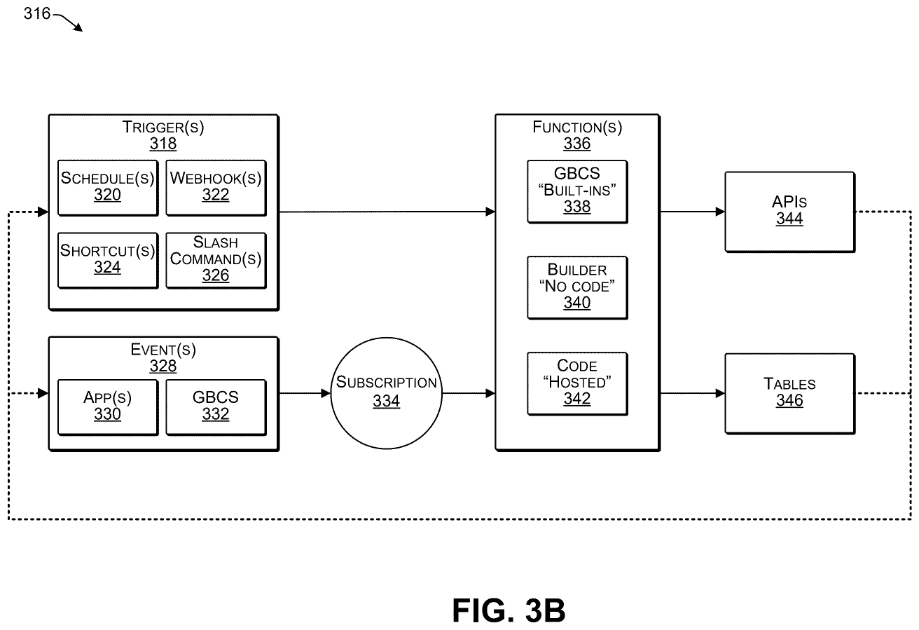

FIG. 2D illustrates user interface 200 displaying a collaboration document pane 264. A collaborative document may be any file type, such as a PDF, video, audio, word processing document, etc., and is not limited to a word processing document or a spreadsheet. A collaborative document may be modified and edited by two or more users. A collaborative document may also be associated with different user permissions, such that based on a user's permissions for the document (or sections of the document as discussed below), the user may selectively be permitted to view, edit, or comment on the collaborative document (or sections of the collaborative document). As such, users within the set of users having access to the document may have varying permissions for viewing, editing, commenting, or otherwise interfacing with the collaborative document. In some examples, permissions can be determined and/or assigned automatically based on how document(s) are created and/or shared. In some examples, permission can be determined manually. Collaborative documents may allow users to simultaneously or asynchronously create and modify documents. Collaborative documents may integrate with the group-based communication system and can both initiate workflows and be used to store the results of workflows, which are discussed further below with respect to FIGS. 3A and 3B.

In some examples, the user interface 200 can comprise one or more collaborative documents (or one or more links to such collaborative documents). A collaborative document (also referred to as a document or canvas) can include a flexible workspace for curating, organizing, and sharing collections of information between users. Such documents may be associated with a synchronous multimedia collaboration session, an asynchronous multimedia collaboration session, a channel, a multi-person direct message conversation, and/or a direct message conversation. Shared canvases can be configured to be accessed and/or modified by two or more users with appropriate permissions. Alternatively or in addition, a user might have one or more private documents that are not associated with any other users.

Further, such documents can be @mentioned, such that particular documents can be referred to within channels (or other virtual spaces or documents) and/or other users can be @mentioned within such a document. For example, @mentioning a user within a document can provide an indication to that user and/or can provide access to the document to the user. In some examples, tasks can be assigned to a user via an @mention and such task(s) can be populated in the pane or sidebar associated with that user.

In some examples, a channel and a collaborative document 268 can be associated such that when a comment is posted in a channel it can be populated to a document 268, and vice versa.

In some examples, when a first user interacts with a collaborative document, the communication platform can identify a second user account associated with the collaborative document and present an affordance (e.g., a graphical element) in a sidebar (e.g., the navigation pane 206) indicative of the interaction. Further, the second user can select the affordance and/or a notification associated with or representing the interaction to access the collaborative document, to efficiently access the document and view the update thereto.

In some examples, as one or more users interact with a collaborative document, an indication (e.g., an icon or other user interface element) can be presented via user interfaces with the collaborative document to represent such interactions. For examples, if a first instance of the document is presently open on a first user computing device of a first user, and a second instance of the document is presently open on a second user computing device of a second user, one or more presence indicators can be presented on the respective user interfaces to illustrate various interactions with the document and by which user. In some examples, a presence indicator may have attributes (e.g., appearance attributes) that indicate information about a respective user, such as, but not limited to, a permission level (e.g., edit permissions, read-only access, etc.), virtual-space membership (e.g., whether the member belongs to a virtual space associated with the document), and the manner in which the user is interacting with the document (e.g., currently editing, viewing, open but not active, etc.).

In some examples, a preview of a collaborative document can be provided. In some examples, a preview can comprise a summary of the collaborative document and/or a dynamic preview that displays a variety of content (e.g., as changing text, images, etc.) to allow a user to quickly understand the context of a document. In some examples, a preview can be based on user profile data associated with the user viewing the preview (e.g., permissions associated with the user, content viewed, edited, created, etc. by the user), and the like.

In some examples, a collaborative document can be created independent of or in connection with a virtual space and/or a channel. A collaborative document can be posted in a channel and edited or interacted with as discussed herein, with various affordances or notifications indicating presence of users associated with documents and/or various interactions.

In some examples, a machine learning model can be used to determine a summary of contents of a channel and can create a collaborative document comprising the summary for posting in the channel. In some examples, the communication platform may identify the users within the virtual space, actions associated with the users, and other contributions to the conversation to generate the summary document. As such, the communication platform can enable users to create a document (e.g., a collaborative document) for summarizing content and events that transpired within the virtual space.

In some examples, documents can be configured to enable sharing of content including (but not limited to) text, images, videos, GIFs, drawings (e.g., user-generated drawings via a drawing interface), or gaming content. In some examples, users accessing a canvas can add new content or delete (or modify) content previously added. In some examples, appropriate permissions may be required for a user to add content or to delete or modify content added by a different user. Thus, for example, some users may only be able to access some or all of a document in view-only mode, while other users may be able to access some or all of the document in an edit mode allowing those users to add or modify its contents. In some examples, a document can be shared via a message in a channel, multi-person direct message, or direct message, such that data associated with the document is accessible to and/or rendered interactable for members of the channel or recipients of the multi-person direct message or direct message.

In some examples, the collaboration document pane 264 may comprise collaborative document toolbar 266 and collaborative document 268. In some examples, collaborative document toolbar 266 may provide the ability to edit or format posts, as discussed herein.

In some examples, collaborative documents may comprise free-form unstructured sections and workflow-related structured sections. In some examples, unstructured sections may include areas of the document in which a user can freely modify the collaborative document without any constraints. For example, a user may be able to freely type text to explain the purpose of the document. In some examples, a user may add a workflow or a structured workflow section by typing the name of (or otherwise mentioning) the workflow. In further examples, typing the “at” sign (@), a previously selected symbol, or a predetermined special character or symbol may provide the user with a list of workflows the user can select to add to the document. For example, a user may indicate that a marketing team member needs to sign off on a proposal by typing “! Marketing Approval” to initiate a workflow that culminates in a member of the marketing team approving the proposal. Placement of an exclamation point prior to the group name of “Marketing Approval” initiates a request for a specification action, in this case routing the proposal for approval. In some examples, structured sections may include text entry, selection menus, tables, checkboxes, tasks, calendar events, or any other document section. In further examples, structured sections may include text entry spaces that are a part of a workflow. For example, a user may enter text into a text entry space detailing a reason for approval, and then select a submit button that will advance the workflow to the next step of the workflow. In some examples, the user may be able to add, edit, or remove structured sections of the document that make up the workflow components.

In examples, sections of the collaborative document may have individual permissions associated with them. For example, a collaborative document having sections with individual permissions may provide a first user permission to view, edit, or comment on a first section, while a second user does not have permission to view, edit, or comment on the first section. Alternatively, a first user may have permissions to view a first section of the collaborative document, while a second user has permissions to both view and edit the first section of the collaborative document. The permissions associated with a particular section of the document may be assigned by a first user via various methods, including manual selection of the particular section of the document by the first user or another user with permission to assign permissions, typing or selecting an “assignment” indicator, such as the “@” symbol, or selecting the section by a name of the section. In further examples, permissions can be assigned for a plurality of collaborative documents at a single instance via these methods. For example, a plurality of collaborative documents each has a section entitled “Group Information,” where the first user with permission to assign permissions desires an entire user group to have access to the information in the “Group Information” section of the plurality of collaborative documents. In examples, the first user can select the plurality of collaborative documents and the “Group Information” section to effectuate permissions to access (or view, edit, etc.) to the entire user group the “Group Information” section of each of the plurality of collaborative documents.

### Automation in the Group-Based Communication System

FIG. 3A illustrates user interface 300 for automation in the group-based communication system. Automation, also referred to as workflows, allow users to automate functionality within the group-based communication system. Workflow builder 302 is depicted which allows a user to create new workflows, modify existing workflows, and review the workflow activity. Workflow builder 302 may comprise a workflow tab 304, an activity tab 306, and/or a settings tab 308. In some examples, workflow builder may include a publish button 314 which permits a user to publish a new or modified workflow.

The workflow tab 304 may be selected to enable a user to create a new workflow or to modify an existing workflow. For example, a user may wish to create a workflow to automatically welcome new users who join a channel. A workflow may comprise workflow steps 310. Workflow steps 310 may comprise at least one trigger which initiates the workflow and at least one function which takes an action once the workflow is triggered. For example, a workflow may be triggered when a user joins a channel and a function of the workflow may be to post within the channel welcoming the new user. In some examples, workflows may be triggered from a user action, such as a user reacting to a message, joining a channel, or collaborating in a collaborative document, from a scheduled date and time, or from a web request from a third-party application or service. In further examples, workflow functionality may include sending messages or forms to users, channels, or any other virtual space, modifying collaborative documents, or interfacing with applications. Workflow functionality may include workflow variables 312. For example, a welcome message may include a user's name via a variable to allow for a customized message. Users may edit existing workflow steps or add new workflow steps depending on the desired workflow functionality. Once a workflow is complete, a user may publish the workflow using publish button 314. A published workflow will wait until it is triggered, at which point the functions will be executed.

Activity tab 306 may display information related to a workflow's activity. In some examples, the activity tab 306 may show how many times a workflow has been executed. In further examples, the activity tab 306 may include information related to each workflow execution including the status, last activity date, time of execution, user who initiated the workflow, and other relevant information. The activity tab 306 may permit a user to sort and filter the workflow activity to find useful information.

A settings tab 308 may permit a user to modify the settings of a workflow. In some examples, a user may change a title or an icon associated with the workflow. Users may also manage the collaborators associated with a workflow. For example, a user may add additional users to a workflow as collaborators such that the additional users can modify the workflow. In some examples, settings tab 308 may also permit a user to delete a workflow.

FIG. 3B depicts elements related to workflows in the group-based communication system and is referred to generally by reference numeral 316. In various examples, trigger(s) 318 can be configured to invoke execution of function(s) 336 responsive to user instructions. A trigger initiates function execution and may take the form of one or more schedule(s) 320, webhook(s) 322, shortcut(s) 324, and/or slash command(s) 326. In some examples, the schedule 320 operates like a timer so that a trigger may be scheduled to fire periodically or once at a predetermined point in the future. In some examples, an end user of an event-based application sets an arbitrary schedule for the firing of a trigger, such as once-an-hour or every day at 9:15 AM.

Additionally, triggers 318 may take the form of the webhook 322. The webhook 322 may be a software component that listens at a webhook URL and port. In some examples, a trigger fires when an appropriate HTTP request is received at the webhook URL and port. In some examples, the webhook 322 requires proper authentication such as by way of a bearer token. In other examples, triggering will be dependent on payload content.

Another source of one of the trigger(s) 318 is a shortcut in the shortcut(s) 324. In some examples, the shortcut(s) 324 may be global to a group-based communication system and are not specific to a group-based communication system channel or workspace. Global shortcuts may trigger functions that are able to execute without the context of a particular group-based communication system message or group-based communication channel. By contrast, message- or channel-based shortcuts are specific to a group-based communication system message or channel and operate in the context of the group-based communication system message or group-based communication channel.

A further source of one of triggers 318 may be provided by way of slash commands 326. In some examples, the slash command(s) 326 may serve as entry points for group-based communication system functions, integrations with external services, or group-based communication system message responses. In some examples, the slash commands 326 may be entered by a user of a group-based communication system to trigger execution of application functionality. Slash commands may be followed by slash-command-line parameters that may be passed along to any group-based communication system function that is invoked in connection with the triggering of a group-based communication system function such as one of functions 336.

An additional way in which a function is invoked is when an event (such as one of events 328) matches one or more conditions as predetermined in a subscription (such as subscription 334). Events 328 may be subscribed to by any number of subscriptions 334, and each subscription may specify different conditions and trigger a different function. In some examples, events are implemented as group-based communication system messages that are received in one or more group-based communication system channels. For example, all events may be posted as non-user visible messages in an associated channel, which is monitored by subscriptions 334. App events 330 may be group-based communication system messages with associated metadata that are created by an application in a group-based communication system channel. Events 328 may also be direct messages received by one or more group-based communication system users, which may be an actual user or a technical user, such as a bot. A bot is a technical user of a group-based communication system that is used to automate tasks. A bot may be controlled programmatically to perform various functions. A bot may monitor and help process group-based communication system channel activity as well as post messages in group-based communication system channels and react to members' in-channel activity. Bots may be able to post messages and upload files as well as be invited or removed from both public and private channels in a group-based communication system.

Events 328 may also be any event associated with a group-based communication system. Such group-based communication system events 332 include events relating to the creation, modification, or deletion of a user account in a group-based communication system or events relating to messages in a group-based communication system channel, such as creating a message, editing or deleting a message, or reacting to a message. Events 328 may also relate to creation, modification, or deletion of a group-based communication system channel or the membership of a channel. Events 328 may also relate to user profile modification or group creation, member maintenance, or group deletion.

As described above, subscription 334 indicates one or more conditions that, when matched by events, trigger a function. In some examples, a set of event subscriptions is maintained in connection with a group-based communication system such that when an event occurs, information regarding the event is matched against a set of subscriptions to determine which (if any) of functions 336 should be invoked. In some examples, the events to which a particular application may subscribe are governed by an authorization framework. In some instances, the event types matched against subscriptions are governed by OAuth permission scopes that may be maintained by an administrator of a particular group-based communication system.

In some examples, functions 336 can be triggered by triggers 318 and events 328 to which the function is subscribed. Functions 336 take zero or more inputs, perform processing (potentially including accessing external resources), and return zero or more results. Functions 336 may be implemented in various forms. First, there are group-based communication system built-ins 338, which are associated with the core functionality of a particular group-based communication system. Some examples include creating a group-based communication system user or channel. Second are no-code builder functions 340 that may be developed by a user of a group-based communication system user in connection with an automation user interface such as workflow builder user interface. Third, there are hosted-code functions 342 that are implemented by way of group-based communication system applications developed as software code in connection with a software development environment.

These various types of functions 336 may in turn integrate with APIs 344. In some examples, APIs 344 are associated with third-party services that functions 336 employ to provide a custom integration between a particular third-party service and a group-based communication system. Examples of third-party service integrations include video conferencing, sales, marketing, customer service, project management, and engineering application integration. In such an example, one of the triggers 318 would be a slash command 326 that is used to trigger a hosted-code function 342, which makes an API call to a third-party video conferencing provider by way of one of the APIs 344. As shown in FIG. 3B, the APIs 344 may themselves also become a source of any number of triggers 318 or events 328. Continuing the above example, successful completion of a video conference would trigger one of the functions 336 that sends a message initiating a further API call to the third-party video conference provider to download and archive a recording of the video conference and store it in a group-based communication system channel.

In addition to integrating with APIs 344, functions 336 may persist and access data in tables 346. In some examples, tables 346 are implemented in connection with a database environment associated with a serverless execution environment in which a particular event-based application is executing. In some instances, tables 346 may be provided in connection with a relational database environment. In other examples, tables 346 are provided in connection with a database mechanism that does not employ relational database techniques. As shown in FIG. 3B, in some examples, reading or writing certain data to one or more of tables 346, or data in table matching predefined conditions, is itself a source of some number of triggers 318 or events 328. For example, if tables 346 are used to maintain ticketing data in an incident-management system, then a count of open tickets exceeding a predetermined threshold may trigger a message being posted in an incident-management channel in the group-based communication system.

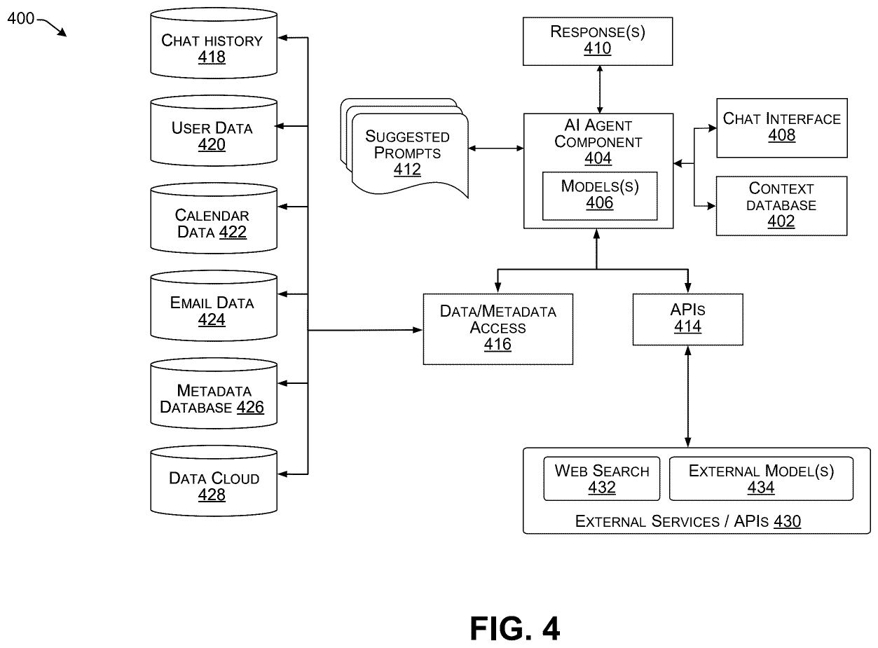

FIG. 4 illustrates an example architecture 400 for generating response(s) 410 and suggested prompts 412 utilizing model(s) 406 associated with an AI agent component 404. The AI agent component 404 may be the same or similar to the AI agent component 120 discussed in relation to FIG. 1. Components and/or modules illustrated in FIG. 4 may be maintained by, or associated with, one or more servers associated with a service provider (e.g., a communication platform). In some examples, the model(s) 406 associated with the AI agent component 404 may be external model(s) associated with an external service(s)/APIs.

The architecture 400 includes a chat interface 408 component that is configured to accept user input. For example, the chat interface 408 component can receive a variety of input types from a user including text input (i.e., typed questions, prompts, or requests), image file(s), document uploads, list(s), video file(s), audio file(s), etc. The user input may be a prompt that defines a task to be performed using the AI agent component 404. The prompt may be a request from a user in the form of a text string defining a task to be performed and received from a user computing device associated with the user. For example, the user input can comprise a request to create a document to track user feedback, analyze feedback trends, generate a survey, and the like.

The AI agent component 404 can be associated with one or more model(s) 406. The model(s) 406 may include LLM models, generative AI models, machine-learned models, and so on. Specific examples of such models may include OpenAI® and/or Vertex AI®. In examples, the models 406 may include any type of machine learning models, large language models (LLM) (e.g., LLM-based models), generative AI models, neural networks, artificial neural networks, decision trees, support-vector machines, regression analysis, Gaussian processes, convolution neural networks, recurrent neural networks, Bayesian neural networks, foundation models, ensemble models, transformers, encoders/decoders, and so on.

In some examples, a service provider that provides the AI agent component 404 may utilize data maintained by the service provider to train untrained or pre-trained models to generate trained models. For instance, the service provider may include functionality to receive real data, modified data, and/or simulated data to train one or more untrained neural networks to generate a plurality of trained neural networks. During training, weights, filters, connections between layers, and/or parameters may be adjusted for training the individual untrained neural networks to perform a task. In some instances, supervised learning/training, unsupervised learning/training, semi-supervised learning/training, reinforcement learning/training, feature learning/training, federated learning/training, and/or self learning/training may be utilized.

Additional or alternate examples of architectures may include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, RoBERTa, XLNet, GPT-2, GPT-3, or the like.

Moreover, in various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Referring back to FIG. 4, the AI agent component 404 may be configured to utilize model(s) 406 to generate suggested prompts 412 and responses 410 based in part on accessing a variety of data/metadata. In some instances, a suggested prompt may be a recommended action for the AI agent to perform on behalf of the user. For example, a suggested prompt may recommend the user ask a follow up question(s), generate a document (or other object), summarize content, perform research, generate a reminder, and the like. Response(s) 410 may vary in type, length, etc. based in part on the prompt(s), contextual data associated with the user(s), user preferences, the endpoint of the response (e.g., whether the response is to be posted to a collaborative space such as a channel(s) or an individual user).

In some examples, the model(s) 406 may receive the user input or a selected suggested prompt as input. The model(s) 406 may analyze the input in order to output information that is responsive to the query by the user (e.g., a response(s) 410). In some examples, the AI agent component 404 generates personalized, suggested prompts and responses in part by accessing or obtaining various types of data via a data/metadata access 416 component. The data/metadata access 416 component may enable the AI agent component 404 to access both first party data and third-party data. For instance, the data/metadata access 416 component may enable the AI agent component 404 to access chat history 418, user data 420, calendar data 422, email data 424, a metadata database 426, cloud data 428, and other data that may be associated with a communication platform.

In some examples, the AI agent component 404 is configured to analyze interactions and conversations with a user in order to generate and maintain long-term memory (or memory that persists) about the user. The model(s) associated with the AI agent component 404 may be configured to extract data that can then be stored in a context database 402. In some examples, the context database 402 is associated with a particular user account, group of user accounts, channel(s), or other virtual space(s), etc. associated with the communication platform. Individual threads input into the model(s) 406 contain a sequence of alternating user and AI assistant responses (e.g., in a user/assistant/user/assistant format). The model(s) 406 may be configured to extract data to store in memory from messages such that the extracted data provides additional context for understanding user requests or prompts.

In some examples, the model(s) 406 associated with the AI agent component 404 may be configured to extract data (e.g., as metadata or “memories”) to store in the context database 402. This enables the extracted data to persist beyond a single conversation or interaction with the AI agent. That is, the extracted data can be accessed or referenced when the user(s) interacts with the AI agent at a later time. In some examples, the model(s) 406 may extract metadata from a portion of a conversation with the AI agent (e.g., metadata associated with messages posted by a user and not the responses generated by the AI agent component). In some examples, the AI agent component 404 may be configured to extract and store new metadata that is determined to not already be present in the context database 402. That is, the AI agent may receive and process a first message, determine that the first message is semantically similar to a second message already stored in memory, and determine to not generate a new memory (or additional metadata) associated with the first message, as it may be duplicative. Said differently, the AI agent component 404 may determine that additional metadata (e.g., second contextual data) associated with a user is not stored in the context database 402 and cause the additional metadata to be stored in the context database 402.

In some examples, the AI agent component 404 is configured to store contextual data in the context database 402 based in part on determining that the contextual data is likely to alter, modify, or affect subsequent responses and/or suggested prompts generated by the model(s) 406 a threshold amount. That is, the model(s) 406 extract “memories” that would meaningfully change how the AI agent interacts with the user. In some examples, different types of data may be considered more or less relevant based on whether the data is utilized to generate a user response (e.g., generating an artifact and prepopulating it with data) or utilized to generate a suggested prompt (e.g., suggested prompt indicating “generate a list).

In some examples, the AI agent component 404 may confine related concepts (or related metadata) into a single, compressive data structure that can be referenced more efficiently. For example, the AI agent component 404 can combine metadata including common fields into a JavaScript Object Notation format (JSON), extensible markup language (XML) format, and the like. To provide a non-limiting example, the AI agent may combine a first concept: “prefers factual, measured language” and a second concept: “dislikes hyperbolic terms in profession writing” into a single concept: “prefers factual, measured language over hyperbolic terms in professional writing.” In some instances, the contextual data in the context database may include personally identifiable information (PII) that can identify a user.

In some examples, prior to inputting data into model(s) 406 associated with the AI agent component 404, data (e.g., messages within a thread) can be processed or preprocessed using a classifier. For example, the data may be processed using a lightweight classifier (e.g., MobileNet™, ShuffleNet™, EfficientNet™, etc.). The classifier may be more computationally efficient and require minimal processing power and memory usage. In some examples, the classifier(s) may analyze messages in a thread that do not invoke the AI agent (e.g., messages shared between multiple users within a virtual space). In some examples, a classifier can identify contextual data shared via the communication platform (e.g., messages, threads, user interactions, files, channel data, etc.) and/or extract user contextual data, which can be stored in context database 402. For example, a classifier can analyze a message thread within a virtual space (e.g., channel) between multiple users, detect and/or identify data that the AI agent can utilize to personalize responses to a user prompt, and cause the relevant data to be stored in a database and/or sent to the AI agent component. In this way, messages in a thread between multiple users may be processed in a computationally efficient manner and require less processing power and/or memory usage. To provide a non-limiting example, a classifier may receive (as input) messages between at least a first user, a second user, and a third user. The classifier may process/analyze the written text in the messages and identify an emotional or attitudinal tone conveyed within the messages between the users. For example, the classifier may identify a first tone (e.g., formal, informal, persuasive, optimistic, pessimistic, humorous, sarcastic, empathetic, encouraging, serious, critical, etc.) in message(s) the first user sent to the second user and may identify a second tone in message(s) the first user sent to the third user. That is, the first user may use a different “tone” depending on a recipient of a message (i.e., the intended reader). The tone data associated with the first user may be stored as contextual data in a database. In some examples, the AI agent component retrieves the tone data from the database when generating responses for the first user (e.g., based upon receiving a prompt to “rewrite text in my voice”).

In some examples, prior to storing context data in the context database 402, the AI agent component 404 is configured to determine if a core meaning of the context data already exists in any form so as to avoid storing multiple instances of metadata that indicates the same or similar insight or information. For example, existing contextual data in the context database 402 may indicate that a particular user “prefers factual, measured language over hyperbolic terms in professional writing.” In this example, the AI agent component 404 may avoid generating and/or storing additional contextual data that indicates that the user (1) “shows strong preference for concise, factual writing,” (2) “values concrete language over exaggeration,” or (3) “favors precise, non-hyperbolic communication,” as this additional contextual data expresses the same or similar core preference stored in the context database 402. Extracting the new information or information that is likely to impact future responses reduces noise, computational cost, and storage requirements.

In some examples, prior to storing data (e.g., contextual data) in the context database, the AI agent component 404 may determine whether the data meets one or more criteria. For example, the AI agent component 404 may determine a likelihood that contextual data is going to modify a manner in which the AI agent responds to a user(s). If the likelihood meets or exceeds a threshold, the AI agent component 404 may store the contextual data in the context database 402. If the likelihood does not meet or exceed the threshold, the data may not be stored. In some examples, if the AI agent component 404 determines that the data is not significant (e.g., the contextual data is unlikely to alter subsequent responses), and the AI agent component 404 avoids storing the data in the context database 402. For example, the AI agent component may avoid storing data that is “low-value,” such as routine task discussion, casual conversations between users, meeting scheduling, basic troubleshooting questions, sharing of routine documents, common workplace questions, information that is implied by a user but not explicitly stated, and the like.

In some examples, the AI agent component 404 may determine whether the contextual data conveys fundamentally new information that is not already captured by contextual data stored in the context database 402. If so, the AI agent component 404 may cause the contextual data to be stored or otherwise retained for future reference. In some examples, AI agent component 404 determines whether the contextual data complies with privacy policies. For example, the AI agent component 404 may be configured to store contextual data that is extracted from a user's interactions with the AI agent, but not private messages between the user and another user, and/or data that is classified as protected information. In some examples, the AI agent component 404 may verify that the contextual data is distinct from other contextual data that was extracted during an active conversational session with the AI agent (e.g., during a single conversation). In some examples, the AI agent component 404 may determine whether the contextual data would likely impact future responses if existing contextual data stored in the context database 402 with a similar meaning already exists. If so, the AI agent component 404 causes the contextual data to be stored in the context database 402. In some examples, the AI agent component may be configured to determine whether the contextual data satisfies a threshold number of criteria (e.g., satisfying four or more criteria). If the contextual data satisfies the threshold number of criteria, the contextual data may be stored in the context database 402.

The model(s) 406 may be configured to consider, extract and/or store certain categories of data. For example, the model(s) 406 can identify and extract professional data (e.g., data related to a user role, company, industry, expertise, etc.), communication preference data (e.g., communication style, formality, preferred channels, favorite channels, etc.), personal preference data associated with a user (e.g., time zone, working hours, tools or applications the user interacts with, etc.), background information (e.g. location data, language skills, etc.), goals and priorities of the user (e.g., career objectives, current focus areas, projects, etc.), areas of interest or expertise (e.g., software development, human resources, legal, etc.), behavioral patterns (e.g., response times, communication style, etc.), and the like.

The AI agent component 404 may be configured to generate (or output) suggested prompts 412 and responses 410 based in part on accessing a variety of data/metadata. In some examples, the AI agent component 404 may access chat history 418 data, which can include previous prompts and text inputs provided by the user, including the suggested prompts the user may have selected. In this way, the AI system can generate suggested prompts and responses that are more personalized to the user. In some examples, chat history 418 can include metadata associated with prior messages sent and/or received by a user (e.g., images, videos, GIFs, etc.), read receipts of the user, communication patterns, message status, frequently contacted users, reply speed, group chat messages, muted conversations, emojis and/or reaction data, reaction statistics (e.g., most common reaction), sentiment analysis, communication style of a user (e.g., tone), @mentions, hashtags, and the like.

In some examples, the AI agent component 404 may access user data 420. User data 420 can include data associated with a user of the communication platform. In at least one example, the user data 420 includes user account data, such as communication channels to which the user has been granted access, one or more group identifiers for groups (or, organizations, teams, entities, or the like) with which the user is associated, an indication whether the user is an owner or manager of a communication channel(s), communication channel restrictions, an avatar, an email address, a real name (e.g., John Doe), a username (e.g., j doe), a time zone, and the like. In at least one example, the user data 420 can include permission data associated with permissions of the user. Permissions can indicate channels the user has access to, restrictions on individual channels or workspaces, and the like. In some instances, user data 420 can include metadata associated with files, documents, objects or other records that the user has generated or interacted with. In some examples, user data 420 may include work hours, productivity tracking, project management activity, meeting schedules and/or attendance, interests (e.g., hobbies, music, movies, etc.), marketing data such as transaction history, survey responses, social and relationship data such as co-workers and professional connections, applications and communication platform usage data (e.g., login timestamps, session duration time, features accessed, and the like), browsing history, or any other manner in which the user interacts with the communication platform.

In some examples, the AI agent component 404 may access calendar data 422 associated with a user(s), which can include data related to events, schedules, reminders, and/or availability of a user(s). For example, calendar data 422 may include event details such as a name of an event, description of the event, duration of the event, whether the event is recurring, and/or a priority level of the event. Calendar data 422 may include a list of participants including the organizer of the event, attendees, RSVP states, and the like. Calendar data 422 may also include a location and/or virtual meeting link. Calendar data 422 may include notifications or reminders associated with an event and/or a notification method of the reminder (e.g., email, text, etc.). In some instances, calendar data 422 may include personal scheduling preferences of a user, such as work hour availability of a user, or out-of-office dates, break times, preferred meeting times, etc. In some examples, calendar data 422 may include attached tasks or checklist items associated with an event.

In some examples, the AI agent component 404 may access email data 424 associated with a user(s), which can include, for example, data indicating a sender, recipient(s), subject line, the content of the email, attached files, and the like. In some examples, the AI agent component 404 may access metadata in the metadata database 426 associated with the communication platform. Metadata can include, for example, message properties (e.g., message ID, thread ID, Channel ID, etc.), user interactions (e.g., sender user ID, user status, etc.), channel details (e.g., channel topic, channel purpose, channel type, channel name, channel ID, channel creator, etc.), timestamps, system-generated data (e.g., automated responses), security and access metadata (e.g., user access roles, authentication data, etc.) and the like.

In some examples, the AI agent component 404 may access cloud data 428 stored on a cloud server(s). Cloud data 428 may include, for example, message history data stored on a cloud server(s), cloud-stored files and attachments, workspace and organizational data (e.g., integration of third-party application data), and the like.

In some examples, the AI agent component 404 may include a document tool that allows a user to upload documents (e.g., PDF files, Word documents, . txt files, PowerPoint documents/slides, etc.). Upon receiving the document as input, the AI agent component 404 may analyze the document, extract data from the document, provide a summary of the document, suggest prompts that the user may ask regarding the document, and/or provide one or more suggested changes or revisions to the document.

In some examples, the AI agent component (e.g., utilizing model(s) 406) is configured to extract contextual or relevant data from files, documents, transcripts, other objects or data records, communications, etc. and tokenize, encode or otherwise process the extracted contextual or relevant data to generate user-specific and personalized responses. In at least one example, the extracted contextual or relevant data may be stored in a database or memory associated with a user for subsequent retrieval.

In some examples, the AI agent component 404 is configured to invoke APIs 414. In some instances, the AI agent component 404 is configured to make tool-enabled API calls (or function calls) by using functions, enabling the querying of databases, making API requests, or executing code. In some examples, the AI agent component 404 is configured to invoke multiple tools (or multiple functions) associated with the communication platform in parallel and/or in a chain in response to a prompt. Tools or functions may include, for example, a search function, APIs, databases, applications, etc. In some examples, the AI agent component 404 may be configured to format a request into a structured format for an external tool (e.g., an API call). For example, the AI agent component 404 may receive a prompt to “generate a document listing what User A has worked on this week.” In this particular example, the AI agent component 404 may first invoke a search function and then invoke a document tool configured to generate the document.

The AI agent component 404 may also utilize one or more external services/APIs 430 that allow for additional information to be obtained from and included as part of the output from the model(s) 406. For instance, web search 432 may be utilized to obtain information from one or more external websites, such as news and current events, science and research articles, finance and stock market data, and the like. In some examples, the AI agent component 404 may interact with external model(s) 434 associated with external services/APIs through API calls, external APIs, cloud-based AI services, and/or plugins.

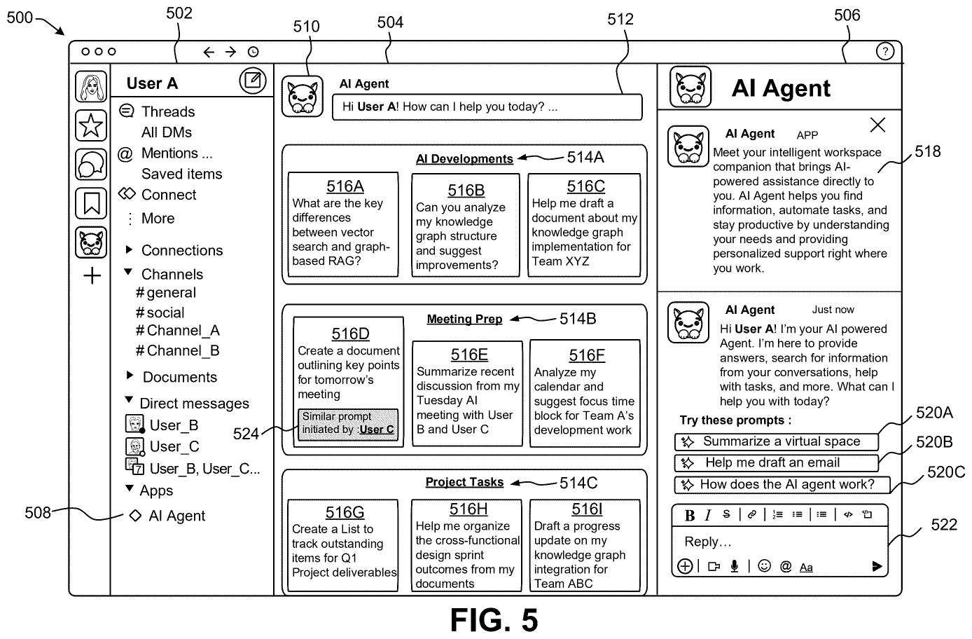

FIG. 5 illustrates a user interface 500 for displaying a plurality of suggested prompts generated by the AI agent 510 for a user (e.g., User A). The plurality of suggested prompts may be presented to a user for the purpose of enhancing the user experience, improving workflows, assisting the user in completing tasks, projects, communicating with other users, etc. The AI agent 510 may be associated with an AI agent component 404 as discussed above in relation to FIG. 4.

As shown, the user interface 500 may include a first region 502, or pane, that including indicator(s) (e.g., user interface element(s) or object(s)) associated with workspace(s), thread(s), connection(s), document(s), application(s), and direct message(s), etc. with which the user (e.g., account of the user) is associated and/or indicator(s) (e.g., user interface element(s), affordance(s), object(s), etc.) representing data associated with the workspace(s), thread(s), connection(s), document(s), application(s), and direct message(s) with which the user (e.g., account of the user) is associated. In at least one example, the first region 502 can represent a sidebar of the user interface 500.

In some examples, the user interface 500 can include a second region 504, or pane, that can be associated with data (or, “feed”) indicating objects (e.g., suggested prompts, messages, documents, videos, etc.) posted to and/or actions taken with respect to the AI agent and/or one or more communication channels as described herein. In at least one example, data associated with the second region 504 can be associated with a homepage of an AI agent application. In some examples, the data presented within the second region 504 may include data associated with a virtual space (e.g., a channel or collaborative document) enabling multiple users to interact with the AI agent.

The second region 504 may include a chat interface 512 associated with an AI agent 510. The user may enter any text (e.g., natural language text, keywords, phrases, queries, questions, prompts, etc.) within the chat interface 512 as a request (or prompt) for the AI agent 510 and/or system(s) and model(s) associated with the AI agent 510 to perform a task. For the purposes of this discussion, the user may also enter, or attach, other types of information within the chat interface 512, such as documents, images, photographs, links, etc. Based on the information input into the chat interface 512 by the user, a model(s) associated with the AI agent may receive the input, process/analyze the input, extract contextual data associated with the user, and generate a response and/or artifact (e.g., document, list, channel, reminder, email, image, video, audio data, etc.) based in part on the extracted contextual data.

In some examples, the second region 504 may include one or more suggested prompt categories for one or more users such that the suggested prompt categories are personalized for individual users or a group of users. The suggested prompts categories may relate to different topics, subject matter, projects, etc. that are determined to be relevant to the user or group of users. For example, user interface 500 presents three suggested prompt categories (e.g., first prompt category 514A, second prompt category 514B, and third prompt category 514C), although any number of prompt categories may be presented. A suggested prompt category may be determined based in part on a job, role, title, and/or position of a user (e.g., machine learning or AI development, marketing specialist, trainee, research specialist, CEO, etc.). In some examples, model(s) associated with the AI agent may generate a suggested prompt category based in part on tasks a user performs frequently or on a regular basis (e.g., daily, weekly, once a month, etc.), determining the user has an upcoming meeting (e.g., “Meeting Preparation” prompt category including suggested prompts that assist a user prepare for an upcoming meeting), determining the user is working on a particular project (e.g., “Project Tasks” prompt category including suggested prompts to assist a user with particular project), and the like.

In at least one example, the suggested prompt categories may be presented in association with a virtual space (e.g., a channel) or other shared collaborative space such that multiple users can view and/or interact with the suggested prompts within one or more suggested prompt categories. For example, a suggested prompt category (e.g., titled “Team A Task List following meeting last week”) within Channel_A may include reminders or tasks that are assigned or intended to be performed by multiple users (e.g., User A to edit the document discussed during Team A meeting last week, User B to contact a client, etc.). This enables multiple users within a virtual space to interact with an AI agent within the virtual space.

The suggested prompt categories may be associated with one or more suggested prompts (e.g., first prompt category 514A includes a first suggested prompt 516A, a second suggested prompt 516B, and a third suggested prompt 516C). Though three suggested prompts are presented within the first prompt category 514A, any number of suggested prompts may be provided within a suggested prompt category box. Additionally, though the suggested prompts are presented in association with a suggested prompt category, in at least one example, the suggested prompts may be presented separate from a category (such as a discrete suggested prompt). Additional examples of suggested prompts are illustrated in FIG. 5, including a fourth suggested prompt 516D, a fifth suggested prompt 516E, a sixth suggested prompt 516F, a seventh suggested prompt 516G, an eighth suggested prompt 516H, and a ninth suggested prompt 516I.

The content of the suggested prompts may be based on information associated with the user, such as a role/position of the user, a user profile of the user, accounts, clients, or projects that the user is currently handling or has previously completed, previous suggested prompts generated for the user, actions previously taken by the user, conversations with other users within the group-based communication platform, including messages sent or posted by the user and messages received by the user via the group-based communication platform, calendar data, email data and so on.

In the example illustrated in FIG. 5, the first suggested prompt indicates that User A may be interested in requesting the AI agent answer a particular question: “what are the key differences between the vector search and graph-based RAG?” A suggested prompt may be selected by a user via the user interface 500. In response to receiving an indication of selection of a suggested prompt (or an indicator associated with the suggested prompt), model(s) associated with the AI agent may receive the selected suggested prompt as input. The model(s) may analyze the input and output information that is responsive to the request or query by the user. For example, in response to receiving an indication of selection of the first suggested prompt 516A, the model(s) may generate an output including key differences between vector search and graph-based RAG. In some examples, the output may be in the form of a message in a “thread” (e.g., posted within second region 504 and/or third region 506) and/or a private message. In some examples, the output may be displayed as a message within a box associated with the suggested prompt. For instance, the response to the first suggested prompt 516A may be displayed in a dialogue box positioned at or proximate a location of the selected suggested prompt on the user interface 500. In some examples, the output may include a partial response (or summary of a response) to the prompt in addition to a link including the complete response that the user can access, share, save for future reference, etc.

In some examples, a prompt category may be associated with one or more types of suggested prompts. Types of suggested prompts may include questions or explanations of key concepts (e.g., what are the key differences between the vector search and graph-based RAG?”), research prompt (e.g., what are some recent developments in machine learning?), analyzation prompt (e.g. “can you analyze my knowledge graph structure and suggest improvements?”), summarization prompt (e.g., “summarize recent discussion from my meeting with User B and User C”), generating an artifact (e.g. “create a list to track outstanding items for Q1 project deliverables”), problem solving (e.g., “help me plan a project” or “what is a solution to challenge A”), recommendation prompt (e.g., “provide suggested edits to a document”), and the like. In some examples, suggested prompts may be sorted, organized, and/or presented based in part on a likelihood that a user will select a suggested prompt relative to other prompts. In some instances, a suggested prompt category may include suggested prompts of the same or different types (e.g., one of an analyzation prompt, an artifact prompt, and/or a summarization prompt, etc.).

In some examples, a suggested prompt may be associated with one or more indicator(s) (e.g., user interface element(s), affordance(s), object(s), etc.) indicating additional information about the suggested prompt. Additional information regarding a suggested prompt may include one or more of a degree of importance of the suggested prompt (e.g., a score between 1-5 indicating a degree of importance) or a popularity of the suggested prompt (e.g., determined by how frequently other users initiate the prompt). In some examples, an indicator may indicate that a similar prompt was recently initiated by a different user with a similar role, interest, shared channels, and/or experience level as the user. For example, fourth suggested prompt 516D is associated with an indicator 524 indicating that the fourth suggested prompt 516D was recently initiated by User C.

In some examples, the communication platform may update the suggested prompt categories and/or suggested prompts periodically (e.g., once an hour, during a particular time of day, once a day, every weekday, etc.) and/or based in part on detecting a trigger event. In some instance, a trigger event may include receiving additional prompts, relevant user data, and/or other contextual data. As discussed above, relevant data may include the interests of a user, goals, and/or preferences of the user, including, for example, communication preferences (e.g., preferred tone, style, and/or level of detail provided in responses).

In at least one example, the user interface 500 may include a third region 506, or a “thread-pane” in which a user (or users) can interact with the AI agent 510. In some examples, the communication platform can cause the second region 504 and/or the third region 506 to be presented in response to receiving an indication that a user selected the AI agent application element 508 in the first region 502. In some examples, the AI agent may initiate a conversation 518 with a user. In some instance, the AI agent component associated with the AI agent may generate one or more suggested prompts for the user based in part on data/metadata accessible to the AI agent component 404 (as discussed above in relation to FIG. 4.) For example, based in part on identifying new communication(s) or a threshold number of interactions (e.g., messages, replies, emojis, posts, etc.) within a virtual space, the AI agent component may generate a first suggested prompt 520A to summarize the virtual space. In another example, based in part on identifying an unread email from an important sender (e.g., a supervisor or a client) in an email inbox of the user, the AI agent component may generate a second suggested prompt 520B to help the user draft an email or a response to the email. As another non-limiting example, in response to determining that the user has recently joined the communication platform, the AI agent component may generate a third suggested prompt 520C asking “how does the AI agent work?” or “what tasks can the AI agent perform?” A user can select a suggested prompt or input text into entry field 522 to request or prompt the AI agent component to perform one or more actions.

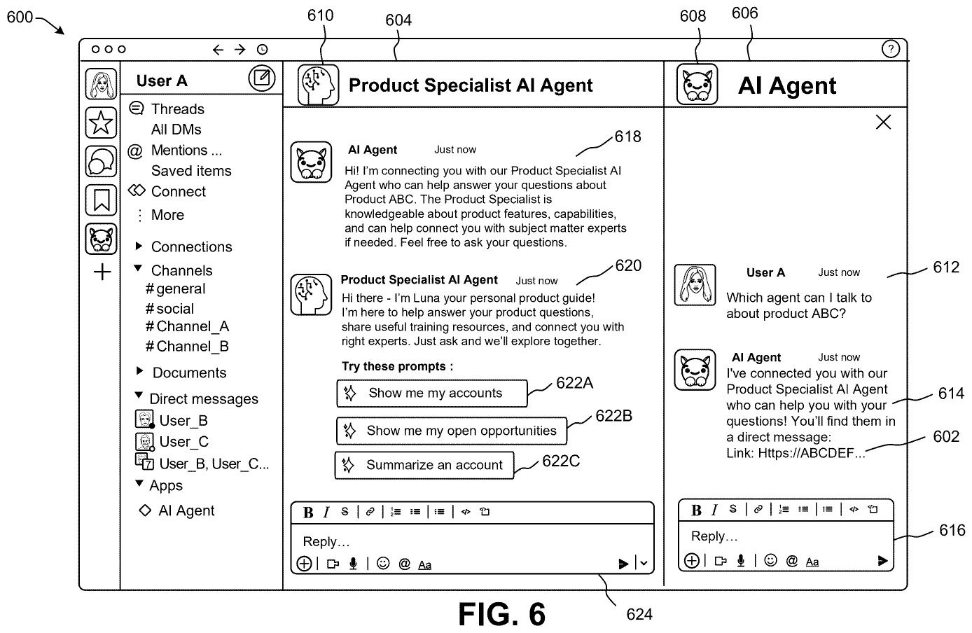

FIG. 6 illustrates a user interface 600 displaying a first AI agent 608 recommending and communicating with a second AI Agent 610. In some examples, the first AI agent 608 may be configured to process inputs, prompts, or perform tasks of a first type (e.g., workspace related inputs, prompts, or tasks) and/or access data from a first source(s) (e.g., a particular database(s)) while a second AI agent 610 may be configured to process a different set of inputs, prompts, perform tasks of a different type than the first AI agent 608 and or access data from a second source(s). In some examples, the first AI agent 608 and the second AI agent 610 may be associated with model(s) that are trained, pre-trained, or fine-tuned utilizing different sets of training data. The second AI agent 610 may be configured to answer questions regarding a particular topic. For example, the second AI agent 610 may be a code quality agent configured to review code and suggest improvements in code, a benefits agent configured to answer questions about employment benefits, internal support agent configured to help with technical issues and employee queries, recognition agent configured to celebrate achievements and milestones, a project assistant agent configured to assist with project updates and insights, an open enrollment agent configured to guide a user through selecting benefits, or a meeting assistant agent configured to help a user prepare for meetings, and the like.

As shown, a user may prompt 612 the first AI agent 608 to perform a task by inputting text into first entry field 616 shown in a second region 606 of the user interface 600. In the particular example, the user asks the first AI agent 608 which agent can answer questions about a product. In some examples, the prompt 612 may be input into model(s) associated with an AI agent component. Based on the user query, the first AI agent 608 outputs a response 614 including a recommendation for a second AI agent that can assist the user. For example, the use input (or text) can be converted into tokens (e.g., words, individual characters, etc.) and assigned identifiers. Individual tokens may be mapped to a high-dimensional embedding vector that encodes semantic information about a word's meaning and context. Tokens may be compared to other tokens and weighted based on relevancy or context. The tokens are then converted back to human-readable text and presented to the user as a response via user interface 600.

Based on the prompt 612, model(s) associated with the AI agent component generate a response 614 recommending a second AI agent 610. The second AI agent 610 may be a product specialist AI agent configured to answer questions about a particular product. In some examples, the response 614 includes a link 602 to an instance of a communication interface with the second AI agent 610. In some examples, actuating the link 602 may cause presentation of a chat interface including communication(s) with the second AI agent 610 (e.g., by causing presentation of a separate window, or presentation within a first region 604 of the user interface 600). The user can share the link 602 with other users or virtual spaces (e.g., channels). In some instances, a second user that has access to the shared link can also interact with the second AI agent 610 (e.g., view interactions, provide prompts, and/or select suggested prompts).

In some examples, the first AI agent 608 may automatically open a new chat with the second AI agent 610 within a first region 604 of the user interface 600. The first AI agent 608 may generate a message 618 introducing the first AI agent 608 and/or providing a summary of topics the first AI agent 608 is knowledgeable in (e.g., product features and/or capabilities, etc.). In some examples, the message 618 may be visible (or accessible) to the user (e.g., User A) and not other users or other AI agent(s). In alternative examples, the message 618 may be directed to the second AI agent 610. In this example, the message 618 may be input and processed by one or model(s) associated with the second AI agent 610, saving the user the step of inputting a second prompt into a second entry field 624. In some examples, model(s) associated with the second AI agent 610 may automatically generate a response based on the prompt 612 and/or message 618 (which can behave as a second prompt from the first AI agent). In some instances, any contextual data that may have been relevant to generate a response (e.g., the conversation between the user and the first AI agent 608) can be used in part to generate response 620 and/or suggested prompts (e.g., first suggested prompt 622A, second suggested prompt 622B, and third suggested prompt 622C).

In some examples, the user may continue to interact with the first AI agent 608 via the first entry field and/or by interacting with first suggested prompts as well as interact with the second AI agent 610 using the second entry field and/or by interacting with second suggested prompts generated by model(s) associated with the second AI agent 610 via user interface 600. That is, the user interface 600 permits the user to interact with multiple AI agents simultaneously such that the user is not required to navigate between multiple windows or user interfaces.

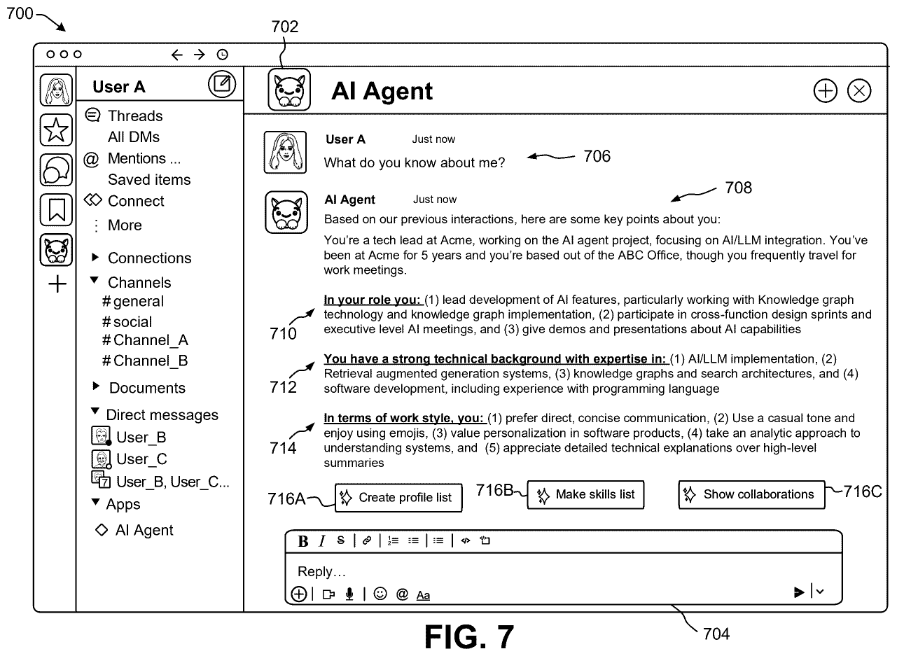

FIG. 7 illustrates an example user interface 700 displaying user summary data 708 generated utilizing model(s) associated with an AI agent 702. In some examples, a user may input a request 706 in entry field 704 for the AI agent 702 to generate summary data for a particular user (e.g., for the user that made the request or a different user).

In response to receiving the request 706, model(s) associated with an AI agent may extract contextual user data associated with the particular user. The model(s) may be configured to extract data stored in a context database associated with the particular user. For example, an AI agent component may be configured to obtain data/information currently known about the user, such as their position/role within an organization, previous actions taken by the user, accounts the user has worked on, previous artifacts (e.g., document, list, channel, etc.) generated or accessed by, the user, and/or any other information/data that may be helpful to utilize, by the model(s), to generate a response and/or suggested follow up prompts. In some embodiments, the contextual data is retrieved from a database maintained by a service provider. In some examples, the model(s) may utilize data currently known about the user and generate inference data about the user's role, expertise, work style, etc.

Based on the contextual data, the model(s) may generate summary data 708 for the particular user, such as a role of the particular user (e.g., tech lead), projects the user is working on (e.g., working on the AI agent project, focusing on AI/LLM integration), time worked at an organization (e.g., worked at Acme for 5 years), a primary work location, how frequently the user travels for work, etc. In some examples, the summary data 708 may be organized into one or more sections. For example, a first section 710 may include data related to a role of the user (e.g., position, projects, work habits, etc.), a second section 712 may include data related to an area of expertise (e.g., expertise in retrieval augmented generation systems), and a third section 714 may include data related to work style (e.g., communication preferences). Though three sections are illustrated in FIG. 7, any number of sections may be generated and/or presented via user interface 700. In some instances, the model(s) associated with the AI agent may be utilized to generate suggested prompts, such as first suggested follow-up prompt 716A, second suggested follow-up prompt 716B, and third suggested follow-up prompt 716C.

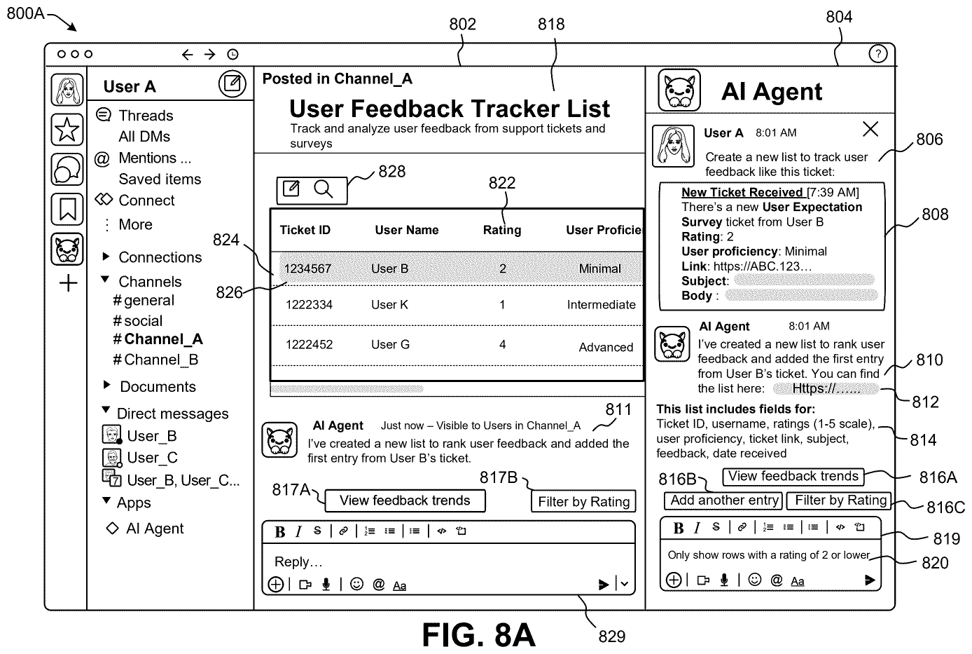

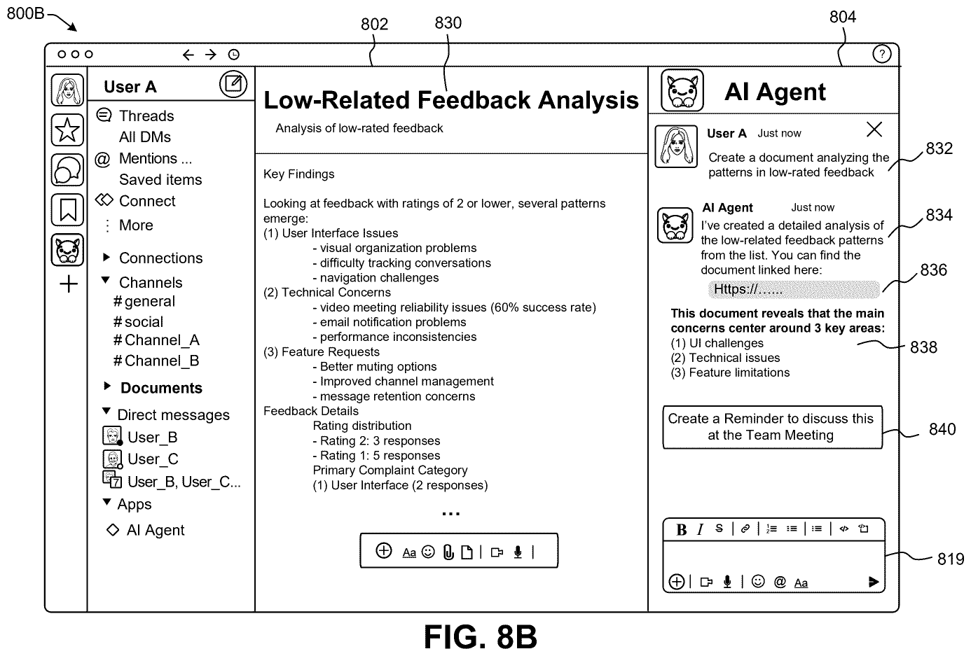

FIG. 8A illustrates an example user interface 800A associated with a communication platform displaying a list 818 generated using an AI Agent. A user may request 806 an AI agent generate a new list to track user feedback. The user may additionally provide an example ticket 808 as additional context. In response to the request 806, an AI agent component may utilize model(s) to generate a response 810 based at least in part on the user request 806 and extracted contextual data associated with the user. The response 810 may be associated with a link 812 to the list 818 and/or a summary 814 of the list (e.g., fields that have been included in the list). In some examples, the response may include one or more suggested follow-up prompts (e.g., first follow-up prompt 816A, second follow-up prompt 816B, and third follow-up prompt 816C). As illustrated in FIG. 8A, rather than selecting a suggested follow-up prompt, a user may input text 820 into first entry field 819.

The list 818 may include a toolbar 828 that enables a user to edit the list 818 and/or perform a search. The list 818 may include any number of columns and/or rows (e.g., rating column 822). A first entry 824 of the list may include data from ticket 808. That is, the AI agent may pre-populate the generated list with one or more data entries. In some examples, the first entry 824 may be associated with an indicator 826 (e.g., an interface element, object, shading, etc.) indicating that the first entry 824 includes data that was provided by the user or that the entry includes data that may be of particular interest to the user.

In some examples, the first section 804 of the user interface 800A may be associated with a thread including messages between a user and an AI agent. The thread may be visible to only the user (i.e., as private a message). The second section 802 may include data that is posted in a shared virtual space (e.g., Channel_A) and may be visible to members of the virtual space (e.g., based on permissions). In at least one example, User A may share the list 818 in Channel_A using the link 812. In some examples, the AI agent may automatically post an instance of the list in Channel_A (or another shared workspace) based on contextual data associated with the user and/or the Channel_A. The AI agent may additionally or alternatively post a response 811 corresponding to response 810 in the virtual space.

In some examples, a user may prompt the AI agent to update data (e.g., add a new field, re-arrange fields, remove data, reorganize data, etc.) within the list based on providing input into either first entry field 819 or second entry field 829. In some examples, user(s) associated with the virtual space may edit the list based on permissions associated with the list and/or the virtual space. For example, a member (e.g., a second user) of Channel_A may prompt the AI agent to filter the list by rating by evoking the AI agent by entering “@AI agent” and input into second entry field 829. Alternatively, the second user may select a suggested prompt that was generated and posted by the AI agent within Channel_A (e.g., a first suggested prompt 817A and second suggested prompt 817B).

In some examples, the AI agent may continuously monitor for new data (e.g., new tickets) to add to the list 818. That is, the AI agent may continuously collect and analyze incoming data utilizing model(s), compare the new data to data present in the list 818, and update the list to include the new data. In some examples, the AI agent may continue to update the list 818 periodically (e.g., once an hour, once a day, etc.) or in real-time (or near real-time).

FIG. 8B is a continuation of FIG. 8A and illustrates an example user interface 800B displaying a document 830 generated by using the AI agent. For example, a user may request 832 the AI agent create a document analyzing the patterns in low-rated feedback. The AI agent may generate the document 830 on behalf of the user. The document 830 may be presented within the second section 802 of the user interface 800B. Model(s) associated with the AI agent may generate a response 834 utilizing contextual data stored in a context database associated with the user and/or other data (e.g., data within list 818). The response 834 may include a link 836 to the document 830. The response may additionally or alternatively include a summary 838 of the generated document 830. The response may additionally or alternatively include one or more suggested follow-up prompts related to the request 832 to create a document. For example, model(s) associated with the AI agent may be utilized to generate suggested prompt 840. The suggested prompt 840 may be generated based in part on the AI agent extracting contextual data associated with User A. The extracted contextual data may indicate, for example, that User A has an upcoming meeting, users scheduled to attend the upcoming meeting are interested in a related topic associated with the document (e.g., low-rated feedback), and/or User A prefers to create reminders to discuss certain topics, and the like.

Model(s) associated with the AI agent may generate and present data within document 830 based in part extracted contextual data indicating one or more of a purpose of the document (e.g., the contextual data may indicate the user intends to use the document for personal user, an assignment, a presentation, a meeting, etc.), who will read the document (e.g., contextual data may indicate a likely audience of the document), tone or writing style of the user (e.g., contextual data may indicate the user prefers a formal tone for a corporate document, friendly tone for a blog post, etc.), key points or topics of interest (e.g., contextual data may indicate what information the user is likely to find more interesting or relevant), formatting preferences, prior knowledge (e.g., contextual data may indicate the user is well versed in machine learning), and the like. In the particular example illustrated in FIG. 8B, model(s) associated with the AI agent utilize contextual data associated with User A (e.g., by extracting it from a context database associated with User A) and identify several patterns in the low-related feedback that may be most relevant to User A (e.g., user interface issues, technical concerns, and feature requests).

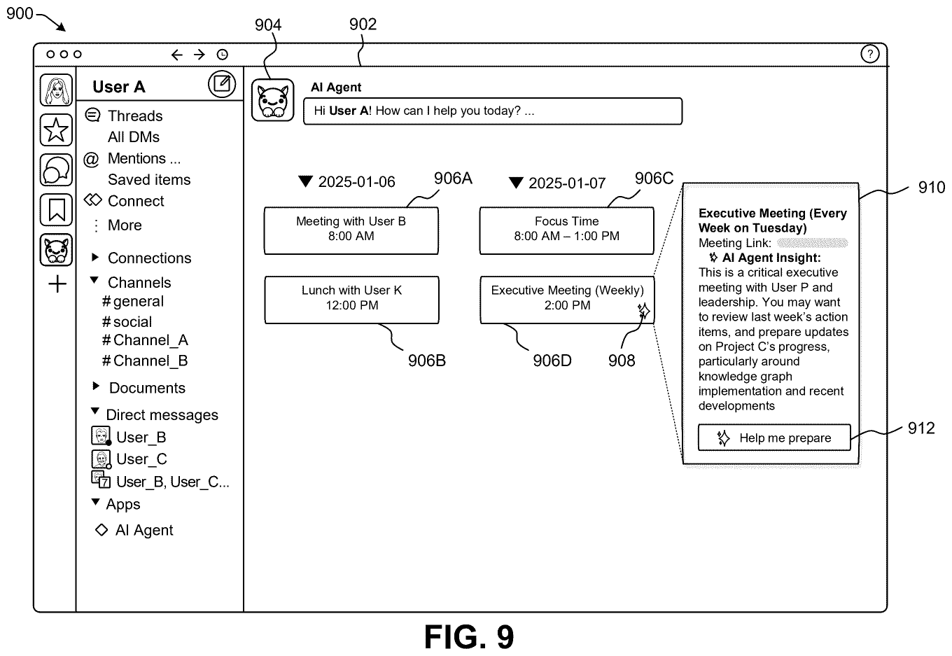

FIG. 9 illustrates an example user interface 900 associated with a communication platform displaying a suggested prompt 912 associated with a calendar event. The AI agent may continuous monitor user interacts with the communication platform. This enables the AI agent to remain up to date on information associated with a particular account, project, topic, event, etc. For instance, AI agent 904 may continuously monitor a calendar and/or email associate with a user. The calendar data and/or email data may be utilized to prepare for a meeting. For example, user interface 900 presents a calendar 902 including event data associated with a user (e.g., first event 906A, second event 906B, third event 906C, and fourth event 906D). Because the AI agent continuously monitors for contextual data, the AI agent can learn to make decisions, reason, and respond to user input with minimal input from the user. For example, based on the AI agent's understanding of User_A's preference and interactions (e.g., User A may have indicated User P and/or other users scheduled to attend the meeting as a VIP member(s), etc.) the AI agent has identified fourth event 906D as being a critical event. In some examples, an event may be associated with an indicator 908 indicating that the AI agent has identified this event as being an important (or critical) event relative to other events in the calendar. In some examples, in response to identifying a calendar event as being a critical event, the AI agent may automatically generate and cause a meeting brief to be sent to the user to help the user prepare. That is, the AI agent can make a decision on behalf of the user.

In some examples, the AI agent may generate one or more suggested prompt(s) 912 and/or insight data 910 associated with a calendar event. Insight data may include a degree of importance (e.g., a numerical score or rating) of the calendar event relative to other events in the calendar and/or events during a particular period of time (e.g., during the week, the month, the quarter, etc.). In some examples, the AI agent may recommend a user perform one or more tasks prior to the time of the calendar event, such as review action items, prepare updates, etc.

In some examples, the AI agent data may automatically generate a document including meeting brief data associated with a calendar event the AI agent has identified as being a critical event without receiving user input (e.g., without receiving an indication of selection of suggested prompt 912). For example, the AI agent may determine the user had previously requested generation of meeting brief data and automatically generates the meeting brief data. The meeting brief data can include data personalized using contextual data associated with the user. For example, the meeting brief can include relevant, recent communications between User A and other users scheduled to attend the meeting, topics related to the user's role (e.g., discussion of recent marketing goals), questions the user may want to ask during the meeting, etc. The AI agent may identify additional relevant data (e.g., communications associated with the calendar event) prior to a time of the calendar event but after a time the document was generated and incorporate that relevant data into the document on behalf of the suer. That is, the AI agent continuously gathers contextual data and automatically updates the meeting brief data in the document based on the newly gathered contextual data.

In some examples, the AI agent may continuously monitor email data and, given the contextual data associated with a user, automatically pull email data into the communication platform. For example, the AI agent may identify an email as being associated with a high priority status by analyzing a tone of the email, content and language, tags, sender information, attachments, links, and the like. Based in part on identifying the email as being high priority, the AI agent may generate a message including the email itself, content of the email, a link to the email, and the like and sending the message to the user via the communication platform.

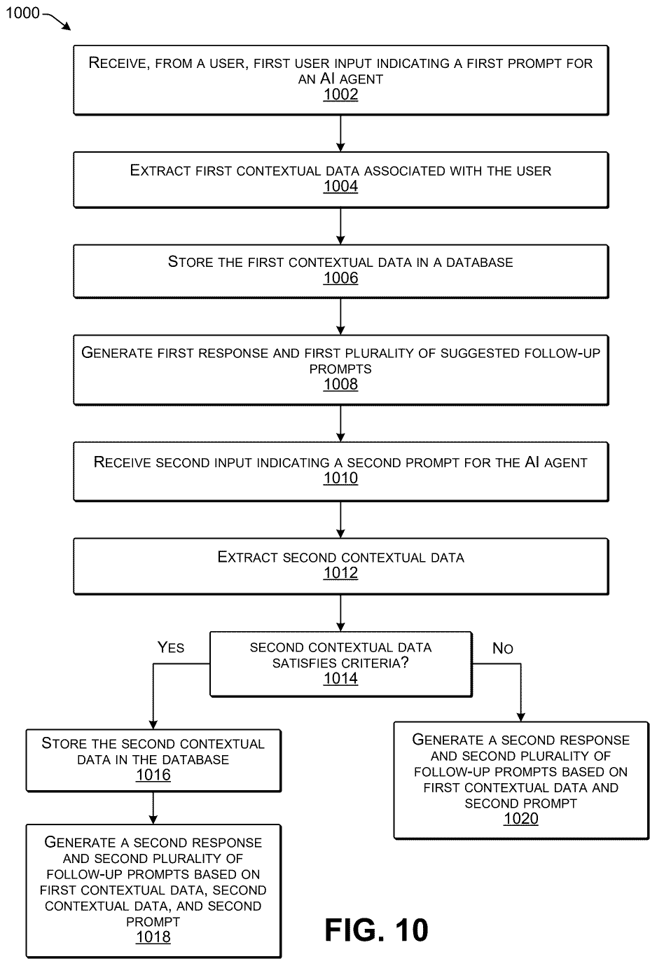

FIG. 10 is a flow diagram illustrating an example process of generating a response to a prompt a including plurality of suggested prompts based on extracting contextual data associated with a user. The processes illustrated in FIG. 10 is described with reference to components described above with reference to the example environments shown in FIGS. 1-9 for convenience and ease of understanding. However, the processes illustrated in FIG. 10 is not limited to being performed using the components described above with reference to the example environments described herein. Moreover, the components described above with reference to the example environments described herein are not limited to performing the processes illustrated in FIG. 10.

Process 1000 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At block 1002, the process 1000 may include receiving first user input from a user. In some embodiments, the user input may include text (and/or other information) input via the chat interface 408 displayed within a user interface accessible via a user device of the user. In other embodiments, the user input may be the selection of a suggested prompt. The user input can indicate a request (or prompt) for the AI agent component to perform a task. In some examples, the task can include a request to generate an artifact (e.g., a document, list, channel, article, report, reminder, etc.). In some examples, a task can include writing or editing a text, generating text, rewriting content for a particular audience or purpose, generating outlines, analyzing data trends, generating charts, graphs, tables, lists and/or an excel spreadsheet, answering questions, researching a topic, performing a live search about a current event, generating images and/or image descriptions, brainstorming creative concepts, assist with planning and prioritizing tasks (e.g., create a schedule, to-do list, etc.), provide checklists and workflow suggestions, automate repetitive tasks through workflow scripting, generate templates, translate text, and the like. For example, a user can input “create a list to track user feedback” into an entry field associated with an AI agent. In some examples, the user may additionally input a list including items ticket items and/or a ticket item in order to provide contextual data for AI agent.

At block 1004, the process 1000 may include extracting first contextual data associated with the user. For instance, upon receiving the user input, model(s) associated with the AI agent component may parse the user input to determine contextual data that may be relevant in generating a personalized response for the user. To continue the example at block 1002, the AI agent component may extract communication preferences associated with the user input (e.g., formal communication style) and list preferences (e.g., favors ticket feedback lists including fields: ticket ID, username, ratings, proficiency, date). In some examples, contextual data can include preferred entries or entry categories, column titles, size of columns, number of rows and/or column, appearance of the list (e.g., font and/or size of text in the list) to be included in a list for the user. As discussed above, the model(s) associated with the AI agent component may leverage various types of data.

At block 1006, the process 1000 may include storing the first contextual data in a database (e.g., context database 402). In some examples, the database is associated with a user account of the communication platform. In some embodiments, the first contextual data may be stored based in part on determining that the contextual data satisfies one or more criteria. For example, to continue the example from block 1004, the AI agent component may determine a probability that contextual data indicating fields a user prefers to be included in a list satisfies a threshold (e.g., the contextual data is likely to impact the columns/row in the list generated for the user).

At block 1008, the process 1000 may include generating a first response and a first plurality of suggested prompts (or suggested follow-up prompts) using the one or more model(s) associated with the AI agent component. In some examples, the model(s) may be utilized to extract data from multiple sources (e.g., internal documents, external documents, websites, calendar data, email data, group-based communication platform data) that are relevant to the user and generate the response and suggested prompts based on the extracted data. For example, to continue the example from block 1006, the model(s) may be utilized to generate a list to track user feedback including the data (e.g., fields) the user prefers, and/or organized in a particular manner based on user preferences. The model(s) may also be utilized to generate one or more suggested follow-up prompts based in part on the contextual data, such as “filter the list by rating,” “view positive data,” “add another entry,” “organize by Ticket ID,” “generate an analysis summary,” “share list with User C,” “post list in Channel_B,” and the like.

At block 1010, the process may include receiving second user input from a user. In at least one example, the second user input is received from a second user. In some examples, the user input may be the selection of a suggested follow-up prompt generated at block 1008. To continue the example from block 1008, the user input can indicate a request to filter the data in the list by rating (e.g., a rating of 2 or lower), a request to reformat the list (e.g., organize the list fields such that “Ratings” appears as the first entry, etc.), a request to generate a summary of the user feedback list, a create a reminder to review the list at a later date, a request to share the list to a virtual space or other user(s), and the like.

At block 1012, the process 1000 may include extracting second contextual data. For example, the model(s) associated with the AI agent extract professional data (e.g., data related to a user role, company, industry, expertise, etc.), communication preference data (e.g., communication style, formality, preferred channels, favorite channels, etc.), personal preference data associated with a user (e.g., time zone, working hours, tools or applications the user interacts with, etc.), background information (e.g. location data, language skills, etc.), goals and priorities of the user (e.g., career objectives, current focus areas, projects, etc.), areas of interest or expertise (e.g., software development, human resources, legal, etc.), behavioral patterns (e.g., response times, communication style, etc.), and the like, based in part on receiving additional input from the user and/or identifying additional information that is relevant to generating a response or suggest prompt(s) (e.g., identifying new calendar entries in a user's calendar). To continue the example from block 1010, model(s) associated with the AI agent component may be utilized to extract list preference data for the user (e.g., generate feedback summary for lists tracking feedback data) based in part on second user input to generate a summary of the user feedback list.

At block 1014, the process 1000 may include determining whether the second contextual data satisfies one or more criteria. For example, model(s) associated with the AI agent component may be used to determine whether the second contextual data satisfies a relevance threshold (e.g., how likely contextual data will impact a manner in which the AI agent component generates response or suggested prompts for a user), whether the second contextual data conveys fundamentally new information that is not already captured in contextual data stored in a context database, whether the second contextual data complies with privacy policies, whether the AI agent component performed a verification process confirming that the second contextual data is district from other contextual data that was created during an active conversational session with the AI agent (e.g., during a single conversation), whether the second contextual data would likely impact future responses generated by the AI agent component if existing contextual data stored in the context database with a similar meaning already exists, whether the second contextual data satisfies a threshold number of criteria (e.g., satisfying three or more criteria), whether the second contextual data includes explicit information or assumptions, and the like.

In some examples, the process 1000 may include determining whether the second contextual data has a core meaning that is similar to contextual data that is stored. That is, similar contextual data can be stored as a single data structure (e.g., or metadata) to improve searching efficiency and conserve computational resources. For example, the AI agent may determine that first contextual data indicating that a user “shows preference for concrete language over hyperbolic description” is similar to and/or conveys the same core meaning as second contextual data indicating the user “values a ‘show don't tell’ approach in professional documentation.” In this particular non-limiting example, the process may include combining the first contextual data and the second contextual data into a single data structure. The combined contextual data may be stored as a single data structure (e.g., metadata indicating the user “prefers concrete, factual ‘show don't tell’ approach in professional writing”). To provide another non-limiting example, the process may include combining first contextual data indicating that the user “developed Admin systems for database operations” and second contextual data indicating that the user “led implantation of zero-downtown database operations” into a single data structure indicating the user “led development of Admin systems enabling zero-downtown database operations.”

If at block 1014, the process 1000 determines that the second contextual data satisfies a criteria and/or a threshold number of criteria, the process 1000 may follow the “YES” route and proceed to block 1016. At block 1016, the process 1000 may include storing the second contextual data in a database. As discussed above, model(s) associated with the AI agent component may be selective of the metadata that is extracted and/or stored in a contextual database. For example, the model(s) may be utilized to generate and store only new metadata that is not already stored in the contextual database and/or store extracted data that is predicted to likely impact future interactions/responses generated for a particular user. In at least one example, the database is a different database than the database at block 1006 (e.g., the second contextual database may be associated with a particular workspace, virtual space, workspace, group of users, a second user, etc.).

At block 1018, the process 1000 may include generating a second response and/or a second plurality of suggested prompts based on the first contextual data, the second contextual data, and the second prompt. That is, the AI agent takes into account the second additional contextual data to generate the second response, further personalizing responses for the user.

If at block 1014, the process 1000 determines that the second contextual data does not satisfy the criteria and/or does not satisfy a threshold number of criteria, the process may follow the “NO” route and proceed to block 1020. At block 1020, the process 1000 generates a second response and second plurality of follow-up prompts based on the first contextual data and the second prompt. To provide a non-limiting example, the AI agent component (utilizing one or more model(s)) may have determined that the second contextual data is unlikely to meaningfully alter a manner in which the AI agent component generates and/or organizes subsequent lists for the particular user. For example, contextual data indicating that the user requested the AI agent filter the list by “Ticket Id” may be unlikely to alter subsequent response(s) and/or subsequent suggested prompts a threshold amount as filtering items by “Ticket Id” may be less useful to user(s) than, for example, organizing by rating or user proficiency. To provide another non-limiting example, the AI agent component may determine that the second contextual data conveys fundamentally similar information when compared to data already stored in a contextual database. For instance, the AI agent component may determine that the contextual database already includes metadata indicating the user prefers to include user proficiency data for lists generated to rank user feedback and, in response, does not store the second contextual data indicating similar user preferences. As another non-limiting example, the AI agent component may determine that the second contextual data violates a privacy policy (e.g., user deleted data) associated with the communication platform.

### Example Clauses

The following clauses provide various examples of implementations of the present disclosure:
A: A system comprising: one or more processors; and one or more non-transitory computer-readable media storing computer-executable instructions that, when executed, cause the one or more processors to perform operations comprising: receiving, from a computing device associated with a user of a communication platform and via a user interface, first input indicating a first prompt for an artificial intelligence (AI) agent, the AI agent associated with a large language model (LLM); extracting first contextual data associated with the user based in part on the first prompt; causing the first contextual data to be stored in a context database; generating a first response and a first one or more suggested follow-up prompts based in part on the first contextual data associated with the user; receiving, from the computing device associated with the user, second input indicating a second prompt for the AI agent; extracting second contextual data associated with the user; determining that the second contextual data is likely to alter a subsequent response or a subsequent suggested follow-up prompt a threshold amount; causing the second contextual data to be stored in the context database; generating a second response and a second one or more suggested follow-up prompts based in part on the first contextual data, the second contextual data, and the second prompt; and causing the second response and the second one or more suggested follow-up prompts to be displayed via the user interface.
B. The system of paragraph A, wherein the first one or more suggested follow-up prompts and the one or more of suggested follow-up prompts are associated with individual selectable elements, the operations further comprising: causing the second one or more suggested follow-up prompts to be sorted and presented based in part on the second contextual data; receiving an indication of selection of a first selectable element associated with the second one or more suggested follow-up prompts; and generating a third response and a third one or more suggested follow-up prompts based in part on receiving the indication of the selection of the first selectable element.
C: The system of paragraph A or B, the operations further comprising: receiving, as a third prompt for the AI agent, a request to generate summary data for the user or a second user associated with the communication platform; in response to the request to generate the summary data, extracting contextual user data associated with the user or the second user; generating, based in part on extracting the contextual user data associated with the user or the second user, at least one of (i) role data indicating a role of the user or the second user, (ii) background data indicating a work experience of the user or the second user, or (iii) communication data indicating a preferred communication style of the user or the second user; and causing at least one of the role data, the background data, or the communication data to be displayed via the user interface.
D: The system of any of paragraph A-C, where the first response and the first one or more suggested follow-up prompts and the second response and the second one or more suggested follow-up prompts are displayed within a virtual space of the communication platform that is accessible to only a subset of users of a plurality of users of the communication platform.
E: The system of any of paragraphs A-D, wherein the user is a first user, the operations further comprising: causing the first response and the first one or more suggested follow-up prompts to be displayed within a virtual space of the communication platform that is accessible to only a subset of users of a plurality of users, the subset of users comprising at least a second user; receiving, from a second computing device associated with the second user, an indication of selection of a second suggested follow-up prompt of the second one or more suggested follow-up prompts; extracting third contextual data associated with the second user; generating a third response and a third one or more suggested follow-up prompts based in part on the third contextual data and the second suggested follow-up prompt; and causing the third response and the third one or more suggested follow-up prompts to be displayed within the virtual space.
F: The system of any of paragraphs A-E, the operations further comprising: receiving a request to display a calendar comprising event data associated with the user; causing the calendar to be displayed via the user interface in association with the AI agent; receiving an indication of selection of a calendar event of one or more calendar events associated with the calendar; based in part on receiving the indication of selection of the calendar event, generating a suggested prompt associated with the calendar event and insight data associated with the calendar event, the insight data comprising one or more of (i) a degree of importance of the calendar event relative to other calendar events, or (ii) a suggested action for the user to perform prior to a time of the calendar event; and causing the suggested prompt and the insight data to be displayed via the user interface in association with the calendar event.
G: The system of any of paragraphs A-F, the operations further comprising: receiving a second indication of selection of the suggested prompt associated with the calendar event; identifying calendar event data and communication data associated with the calendar event; based in part on accessing the calendar event data and the communication data, generating a document comprising meeting brief data associated with the calendar event; and causing the document to be presented via the user interface.
H: The system of paragraph G, the operations further comprising: identifying, prior to the time of the calendar event and without receiving user input, additional communications associated with the calendar event; and automatically updating the document based in part on the additional communications.
I: The system of any of paragraphs A-H, wherein the first prompt for the AI agent comprises a request to generate a document, a list, a workflow, a task, a ticket, a calendar event, a message, or a reminder.
J: The system of any of paragraphs A-I, wherein the first input is at least one of: a text input via a text entry field; or a selection of a suggested prompt of one or more suggested prompts that are displayed via the user interface, wherein the one or more suggested prompts are organized based in part on user data associated with the user.
K: The system of any of paragraphs A-J, wherein the AI agent is a first AI agent, the operations further comprising: receiving, as a third prompt for the first AI agent, a request to perform a task; identifying, by the first AI agent, a second AI agent configured to perform the task; in response to identifying the second AI agent, causing the second AI agent to initiate a communication with the user; generating, by the second AI agent, a third response and a third one or more suggested follow-up prompts based in part on the third prompt; and causing the third response and the third one or more suggested follow-up prompts to be displayed via the user interface.
L: The system of paragraphs A-K, the operations further comprising: accessing email data associated with the user, the email data comprising one or more emails; identifying, by the AI agent, an email associated with a high priority status relative to other emails; generating, by the AI agent, a message comprising the email or a link to the email; and sending the message to the user via the communication platform.
M: A method, implemented at least in part by one or more computing device of a communication platform, the method comprising: receiving, from a computing device associated with a user of the communication platform, first input indicating a first prompt for an artificial intelligence (AI) agent, the AI agent associated with a large language model (LLM); extracting first contextual data associated with the user based in part on the first prompt; causing the first contextual data to be stored in a context database; generating a first response and a first one or more suggested follow-up prompts based in part on the first contextual data associated with the user; receiving, from the computing device associated with the user, second input indicating a second prompt for the AI agent; extracting second contextual data associated with the user; determining that the second contextual data is likely to alter a subsequent response or a subsequent suggested follow-up prompt a threshold amount; causing the second contextual data to be stored in the context database; generating a second response and a second one or more suggested follow-up prompts based in part on the first contextual data, the second contextual data, and the second prompt; and causing the second response and the second one or more suggested follow-up prompts to be displayed via a user interface.
N: The method of paragraph M, further comprising: receiving, as a third prompt for the AI agent, a request to generate summary data for a particular user associated with the communication platform; in response to the request to generate the summary data, extracting contextual user data associated with the particular user; generating, based in part on extracting the contextual user data associated with the particular user, at least one of (i) role data indicating a role of the particular user, (ii) background data indicating a work experience of the particular user, or (iii) communication data indicating a preferred communication style of the particular user; and causing at least one of the role data, the background data, or the communication data to be displayed via the user interface.
O: The method of paragraph M or N, wherein the first response and the first one or more suggested follow-up prompts and the second response and the second one or more suggested follow-up prompts are displayed within a virtual space of the communication platform that is accessible to only a subset of users of a plurality of users of the communication platform.
P: The method of any of paragraphs M-O, wherein the user is a first user, the method further comprising: causing the first response and the first one or more suggested follow-up prompts to be displayed within a virtual space of the communication platform that is accessible to only a subset of users of a plurality of users, the subset of users comprising at least a second user; receiving, from a second computing device associated with the second user, an indication of selection of a second suggested follow-up prompt of the second one or more suggested follow-up prompts; extracting third contextual data associated with the second user; generating a third response and a third one or more suggested follow-up prompts based in part on the third contextual data and the second suggested follow-up prompt; and causing the third response and the third one or more suggested follow-up prompts to be displayed within the virtual space.
Q: The method of any of paragraphs M-P, further comprising: receiving a first indication of selection of a calendar event of one or more calendar events associated with a calendar; based in part on receiving the first indication of selection of the calendar event, generating insight data associated with calendar event, the insight data comprising one or more of (i) a degree of importance of the calendar event relative to other calendar events, or (ii) a suggested action for the user to perform prior to a time of the calendar event; generating a document comprising meeting brief data associated with the calendar event; identifying, prior to the time of the calendar event and without receiving user input, additional communications associated with the calendar event; and automatically updating the document based in part on the additional communications.
R: One or more non-transitory computer-readable media storing instructions that, when executed, cause one or more processors to perform operations comprising: receiving, from a computing device associated with a user of a communication platform and via a user interface, first input indicating a first prompt for an artificial intelligence (AI) agent, the AI agent associated with one or more models; extracting first contextual data associated with the user based in part on the first prompt; causing the first contextual data to be stored in a context database; generating a first response and a first one or more suggested follow-up prompts based in part on the first contextual data associated with the user; receiving, from the computing device associated with the user, second input indicating a second prompt for the AI agent; extracting second contextual data associated with the user; determining that the second contextual data is likely to alter a subsequent response or a subsequent suggested follow-up prompt a threshold amount; causing the second contextual data to be stored in the context database; generating a second response and a second one or more suggested follow-up prompts based in part on the first contextual data, the second contextual data, and the second prompt; and causing the second response and the second one or more suggested follow-up prompts to be displayed via the user interface.
S: The one or more non-transitory computer-readable media of paragraph R, wherein the first input is at least one of: a text input via a text entry field; or a selection of a suggested prompt of a one or more suggested prompts that are displayed via the user interface, wherein the one or more suggested prompts are organized based in part on user data associated with the user.
T: The one or more non-transitory computer-readable media of paragraph R or S, wherein the AI agent is a first AI agent, the operations further comprising: receiving, as a third prompt for the first AI agent, a request to perform a task; identifying, by the first AI agent, a second AI agent configured to perform the task; in response to identifying the second AI agent, causing the second AI agent to initiate a communication with the user; generating, by the second AI agent, a third response and a third one or more suggested follow-up prompts based in part on the third prompt; and causing the third response and the third one or more suggested follow-up prompts to be displayed via the user interface.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed, cause the one or more processors to perform operations comprising:
receiving, from a computing device associated with a user of a communication platform and via a user interface, first input indicating a first prompt for an artificial intelligence (AI) agent, the AI agent associated with a large language model (LLM);
extracting first contextual data associated with the user based in part on the first prompt;
causing the first contextual data to be stored in a context database;
generating a first response and a first one or more suggested follow-up prompts based in part on the first contextual data associated with the user;
receiving, from the computing device associated with the user, second input indicating a second prompt for the AI agent;
extracting second contextual data associated with the user;
determining that the second contextual data is likely to alter a subsequent response or a subsequent suggested follow-up prompt a threshold amount;
causing the second contextual data to be stored in the context database;
generating a second response and a second one or more suggested follow-up prompts based in part on the first contextual data, the second contextual data, and the second prompt; and
causing the second response and the second one or more suggested follow-up prompts to be displayed via the user interface.

2. The system of claim 1, wherein the first one or more suggested follow-up prompts and the one or more of suggested follow-up prompts are associated with individual selectable elements, the operations further comprising:
causing the second one or more suggested follow-up prompts to be sorted and presented based in part on the second contextual data;
receiving an indication of selection of a first selectable element associated with the second one or more suggested follow-up prompts; and
generating a third response and a third one or more suggested follow-up prompts based in part on receiving the indication of the selection of the first selectable element.

3. The system of claim 1, the operations further comprising:
receiving, as a third prompt for the AI agent, a request to generate summary data for the user or a second user associated with the communication platform;
in response to the request to generate the summary data, extracting contextual user data associated with the user or the second user;
generating, based in part on extracting the contextual user data associated with the user or the second user, at least one of (i) role data indicating a role of the user or the second user, (ii) background data indicating a work experience of the user or the second user, or (iii) communication data indicating a preferred communication style of the user or the second user; and
causing at least one of the role data, the background data, or the communication data to be displayed via the user interface.

4. The system of claim 1, where the first response and the first one or more suggested follow-up prompts and the second response and the second one or more suggested follow-up prompts are displayed within a virtual space of the communication platform that is accessible to only a subset of users of a plurality of users of the communication platform.

5. The system of claim 1, wherein the user is a first user, the operations further comprising:
causing the first response and the first one or more suggested follow-up prompts to be displayed within a virtual space of the communication platform that is accessible to only a subset of users of a plurality of users, the subset of users comprising at least a second user;
receiving, from a second computing device associated with the second user, an indication of selection of a second suggested follow-up prompt of the second one or more suggested follow-up prompts;
extracting third contextual data associated with the second user;
generating a third response and a third one or more suggested follow-up prompts based in part on the third contextual data and the second suggested follow-up prompt; and
causing the third response and the third one or more suggested follow-up prompts to be displayed within the virtual space.

6. The system of claim 1, the operations further comprising:
receiving a request to display a calendar comprising event data associated with the user;
causing the calendar to be displayed via the user interface in association with the AI agent;
receiving an indication of selection of a calendar event of one or more calendar events associated with the calendar;
based in part on receiving the indication of selection of the calendar event, generating a suggested prompt associated with the calendar event and insight data associated with the calendar event, the insight data comprising one or more of (i) a degree of importance of the calendar event relative to other calendar events, or (ii) a suggested action for the user to perform prior to a time of the calendar event; and
causing the suggested prompt and the insight data to be displayed via the user interface in association with the calendar event.

7. The system of claim 6, the operations further comprising:
receiving a second indication of selection of the suggested prompt associated with the calendar event;
identifying calendar event data and communication data associated with the calendar event;
based in part on accessing the calendar event data and the communication data, generating a document comprising meeting brief data associated with the calendar event; and
causing the document to be presented via the user interface.

8. The system of claim 7, the operations further comprising:
identifying, prior to the time of the calendar event and without receiving user input, additional communications associated with the calendar event; and
automatically updating the document based in part on the additional communications.

9. The system of claim 1, wherein the first prompt for the AI agent comprises a request to generate a document, a list, a workflow, a task, a ticket, a calendar event, a message, or a reminder.

10. The system of claim 1, wherein the first input is at least one of:
a text input via a text entry field; or
a selection of a suggested prompt of one or more suggested prompts that are displayed via the user interface, wherein the one or more suggested prompts are organized based in part on user data associated with the user.

11. The system of claim 1, wherein the AI agent is a first AI agent, the operations further comprising:
receiving, as a third prompt for the first AI agent, a request to perform a task;
identifying, by the first AI agent, a second AI agent configured to perform the task;
in response to identifying the second AI agent, causing the second AI agent to initiate a communication with the user;
generating, by the second AI agent, a third response and a third one or more suggested follow-up prompts based in part on the third prompt; and
causing the third response and the third one or more suggested follow-up prompts to be displayed via the user interface.

12. The system of claim 1, the operations further comprising:
accessing email data associated with the user, the email data comprising one or more emails;
identifying, by the AI agent, an email associated with a high priority status relative to other emails;
generating, by the AI agent, a message comprising the email or a link to the email; and
sending the message to the user via the communication platform.

13. A method, implemented at least in part by one or more computing device of a communication platform, the method comprising:
receiving, from a computing device associated with a user of the communication platform, first input indicating a first prompt for an artificial intelligence (AI) agent, the AI agent associated with a large language model (LLM);
extracting first contextual data associated with the user based in part on the first prompt;
causing the first contextual data to be stored in a context database;
generating a first response and a first one or more suggested follow-up prompts based in part on the first contextual data associated with the user;
receiving, from the computing device associated with the user, second input indicating a second prompt for the AI agent;
extracting second contextual data associated with the user;
determining that the second contextual data is likely to alter a subsequent response or a subsequent suggested follow-up prompt a threshold amount;
causing the second contextual data to be stored in the context database;
generating a second response and a second one or more suggested follow-up prompts based in part on the first contextual data, the second contextual data, and the second prompt; and
causing the second response and the second one or more suggested follow-up prompts to be displayed via a user interface.

14. The method of claim 13, further comprising:
receiving, as a third prompt for the AI agent, a request to generate summary data for a particular user associated with the communication platform;
in response to the request to generate the summary data, extracting contextual user data associated with the particular user;
generating, based in part on extracting the contextual user data associated with the particular user, at least one of (i) role data indicating a role of the particular user, (ii) background data indicating a work experience of the particular user, or (iii) communication data indicating a preferred communication style of the particular user; and
causing at least one of the role data, the background data, or the communication data to be displayed via the user interface.

15. The method of claim 13, wherein the first response and the first one or more suggested follow-up prompts and the second response and the second one or more suggested follow-up prompts are displayed within a virtual space of the communication platform that is accessible to only a subset of users of a plurality of users of the communication platform.

16. The method of claim 13, wherein the user is a first user, the method further comprising:
causing the first response and the first one or more suggested follow-up prompts to be displayed within a virtual space of the communication platform that is accessible to only a subset of users of a plurality of users, the subset of users comprising at least a second user;
receiving, from a second computing device associated with the second user, an indication of selection of a second suggested follow-up prompt of the second one or more suggested follow-up prompts;
extracting third contextual data associated with the second user;
generating a third response and a third one or more suggested follow-up prompts based in part on the third contextual data and the second suggested follow-up prompt; and
causing the third response and the third one or more suggested follow-up prompts to be displayed within the virtual space.

17. The method of claim 13, further comprising:
receiving a first indication of selection of a calendar event of one or more calendar events associated with a calendar;
based in part on receiving the first indication of selection of the calendar event, generating insight data associated with calendar event, the insight data comprising one or more of (i) a degree of importance of the calendar event relative to other calendar events, or (ii) a suggested action for the user to perform prior to a time of the calendar event;
generating a document comprising meeting brief data associated with the calendar event;
identifying, prior to the time of the calendar event and without receiving user input, additional communications associated with the calendar event; and
automatically updating the document based in part on the additional communications.

18. One or more non-transitory computer-readable media storing instructions that, when executed, cause one or more processors to perform operations comprising:
receiving, from a computing device associated with a user of a communication platform and via a user interface, first input indicating a first prompt for an artificial intelligence (AI) agent, the AI agent associated with one or more models;
extracting first contextual data associated with the user based in part on the first prompt;
causing the first contextual data to be stored in a context database;
generating a first response and a first one or more suggested follow-up prompts based in part on the first contextual data associated with the user;
receiving, from the computing device associated with the user, second input indicating a second prompt for the AI agent;
extracting second contextual data associated with the user;
determining that the second contextual data is likely to alter a subsequent response or a subsequent suggested follow-up prompt a threshold amount;
causing the second contextual data to be stored in the context database;
generating a second response and a second one or more suggested follow-up prompts based in part on the first contextual data, the second contextual data, and the second prompt; and
causing the second response and the second one or more suggested follow-up prompts to be displayed via the user interface.

19. The one or more non-transitory computer-readable media of claim 18, wherein the first input is at least one of:
a text input via a text entry field; or
a selection of a suggested prompt of a one or more suggested prompts that are displayed via the user interface, wherein the one or more suggested prompts are organized based in part on user data associated with the user.

20. The one or more non-transitory computer-readable media of claim 18, wherein the AI agent is a first AI agent, the operations further comprising:
receiving, as a third prompt for the first AI agent, a request to perform a task;
identifying, by the first AI agent, a second AI agent configured to perform the task;
in response to identifying the second AI agent, causing the second AI agent to initiate a communication with the user;
generating, by the second AI agent, a third response and a third one or more suggested follow-up prompts based in part on the third prompt; and
causing the third response and the third one or more suggested follow-up prompts to be displayed via the user interface.
